(19) United States
(12) Patent Application Publication
(10) Pub. No.: US 2024/0412107 A1
(43) Pub. Date: Dec. 12, 2024

(54) MACHINE LEARNING MODEL DEPLOYMENT, MANAGEMENT AND MONITORING AT SCALE

(71) Applicant: Schlumberger Technology Corporation, Sugar Land, TX (US)

(72) Inventors: Yusef Alaas, Sugar Land, TX (US); Hew Boland, Ann Arbor, MI (US); Felipe Klein, Sugar Land, TX (US)

(21) Appl. No.: 18/698,152

(22) PCT Filed: Nov. 18, 2022
(86) PCT No.: PCT/US2022/050340

§ 371 Date: Apr. 3, 2024

Related U.S. Application Data
(60) Provisional application No. 63/281,704, filed on Nov. 21, 2021.

(51) Int. Cl. G06N 20/00

(52) U.S. Cl. CPC G06N 20/00

(57) ABSTRACT

A system can include a machine learning model training framework that generates trained machine learning models; a metadata configurer that generates metadata for trained machine learning model implementation; and a deployment manager that deploys trained machine learning models, metadata or trained machine learning models and metadata to remote devices according to one or more implementation strategies.

### CROSS-REFERENCE TO RELATED APPLICATION(S)

The subject disclosure claims priority from U.S. Provisional Appl. No. 63/281,704, filed on Nov. 21, 2021, herein incorporated by reference in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc., where fluid may be produced via the borehole (e.g., as a completed well, etc.). As an example, one or more workflows may be performed using one or more computational frameworks and/or one or more pieces of equipment that include features for one or more of analysis, acquisition, model building, control, etc., for exploration, interpretation, drilling, fracturing, production, etc.

### SUMMARY

A system can include a machine learning model training framework that generates trained machine learning models; a metadata configurer that generates metadata for trained machine learning model implementation; and a deployment manager that deploys trained machine learning models, metadata or trained machine learning models and metadata to remote devices according to one or more implementation strategies. A method can include generating a trained machine learning model; generating metadata for trained machine learning model implementation; and deploying instances of the trained machine learning model, the metadata or the trained machine learning model and the metadata to remote devices according to one or more implementation strategies. One or more computer-readable media can include computer-executable instructions executable by a system to instruct the system to: generate a trained machine learning model; generate metadata for trained machine learning model implementation; and deploy instances of the trained machine learning model, the metadata or the trained machine learning model and the metadata to remote devices according to one or more implementation strategies. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of systems;

FIG. 3 illustrates an example of a system;

FIG. 4 illustrates an example of a system;

FIG. 5 illustrates an example of a system;

FIG. 6 illustrates an example of a system;

FIG. 7 illustrates an example of a system;

FIG. 8 illustrates an example of a system;

FIG. 9 illustrates an example of a system;

FIG. 10 illustrates an example of a system;

FIG. 11 illustrates an example of a system;

FIG. 12 illustrates an example of a system;

FIG. 13 illustrates an example of a system and an example of a method;

FIG. 14 illustrates an example of a system and an example of a method;

FIG. 15 illustrates an example of a system;

FIG. 16 illustrates an example of a method;

FIG. 17 illustrates examples of computer and network equipment; and

FIG. 18 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

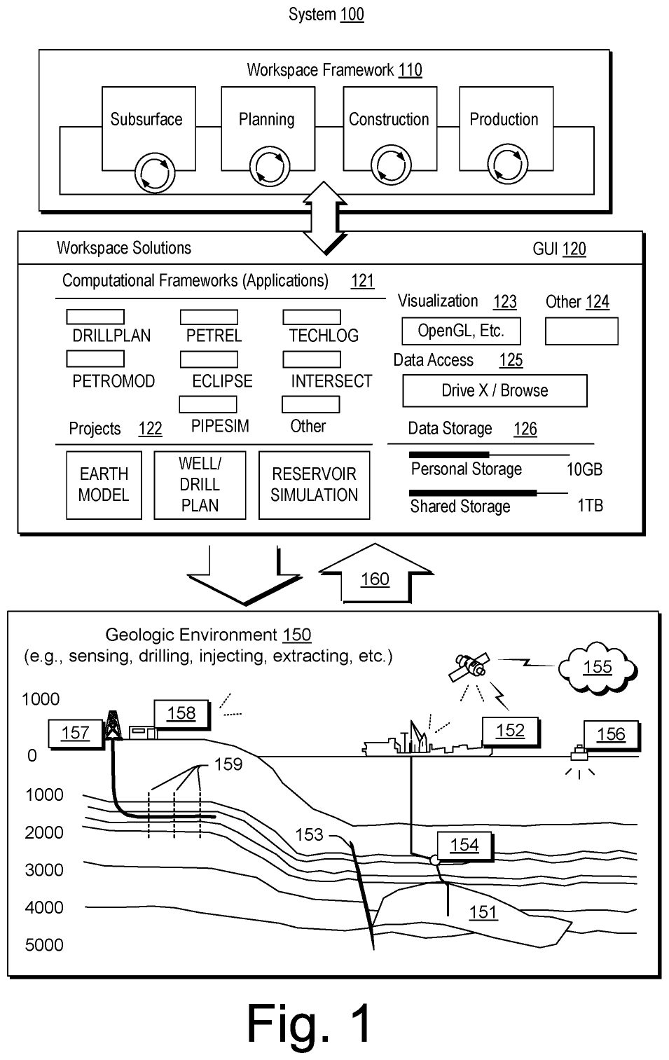

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, PIPESIM, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (Schlumberger Limited, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (Schlumberger Limited, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such an approach can provide for compatibility of devices, frameworks, etc., with respect to one or more sets of instructions.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1 D, 2 D, 3 D or 4 D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator will not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (Schlumberger Limited, Houston Texas) or the PIPESIM network simulator (Schlumberger Limited, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena. The MANGROVE simulator (Schlumberger Limited, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

As mentioned, a framework may be implemented within or in a manner operatively coupled to the DELFI cognitive exploration and production (E&P) environment (Schlumberger, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As an example, data can include geochemical data. For example, consider data acquired using X-ray fluorescence (XRF) technology, Fourier transform infrared spectroscopy (FTIR) technology and/or wireline geochemical technology.

As an example, one or more probes may be deployed in a bore via a wireline or wirelines. As an example, a probe may emit energy and receive energy where such energy may be analyzed to help determine mineral composition of rock surrounding a bore. As an example, nuclear magnetic resonance may be implemented (e.g., via a wireline, downhole NMR probe, etc.), for example, to acquire data as to nuclear magnetic properties of elements in a formation (e.g., hydrogen, carbon, phosphorous, etc.).

As an example, lithology scanning technology may be employed to acquire and analyze data. For example, consider the LITHO SCANNER technology marketed by Schlumberger Limited (Houston, Texas). As an example, a LITHO SCANNER tool may be a gamma ray spectroscopy tool.

As an example, a tool may be positioned to acquire information in a portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the aforementioned TECHLOG framework (Schlumberger Limited, Houston, Texas).

As an example, a workflow may utilize one or more types of data for one or more processes (e.g., stratigraphic modeling, basin modeling, completion designs, drilling, production, injection, etc.). As an example, one or more tools may provide data that can be used in a workflow or workflows that may implement one or more frameworks (e.g., PETREL, TECHLOG, PETROMOD, ECLIPSE, etc.).

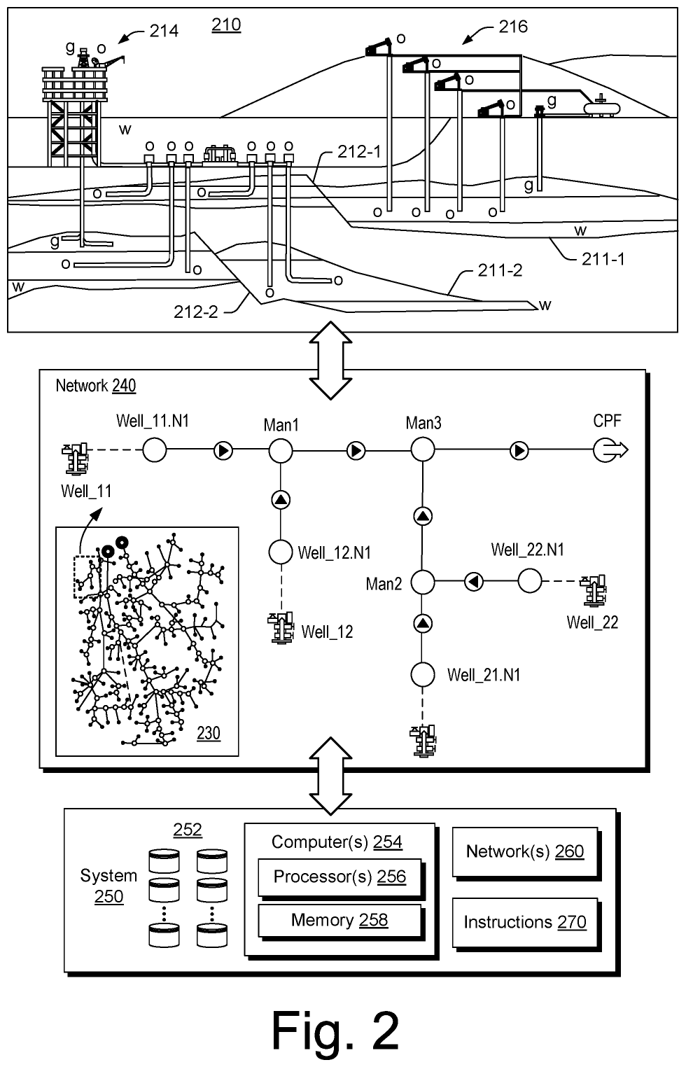

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In the example of FIG. 2, the various equipment 214 and 216 can include drilling equipment, wireline equipment, production equipment, etc. For example, consider the equipment 214 as including a drilling rig that can drill into a formation to reach a reservoir target where a well can be completed for production of hydrocarbons. In such an example, one or more features of the system 100 of FIG. 1 may be utilized. For example, consider utilizing the DRILLPLAN framework to plan, execute, etc., one or more drilling operations.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduits. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

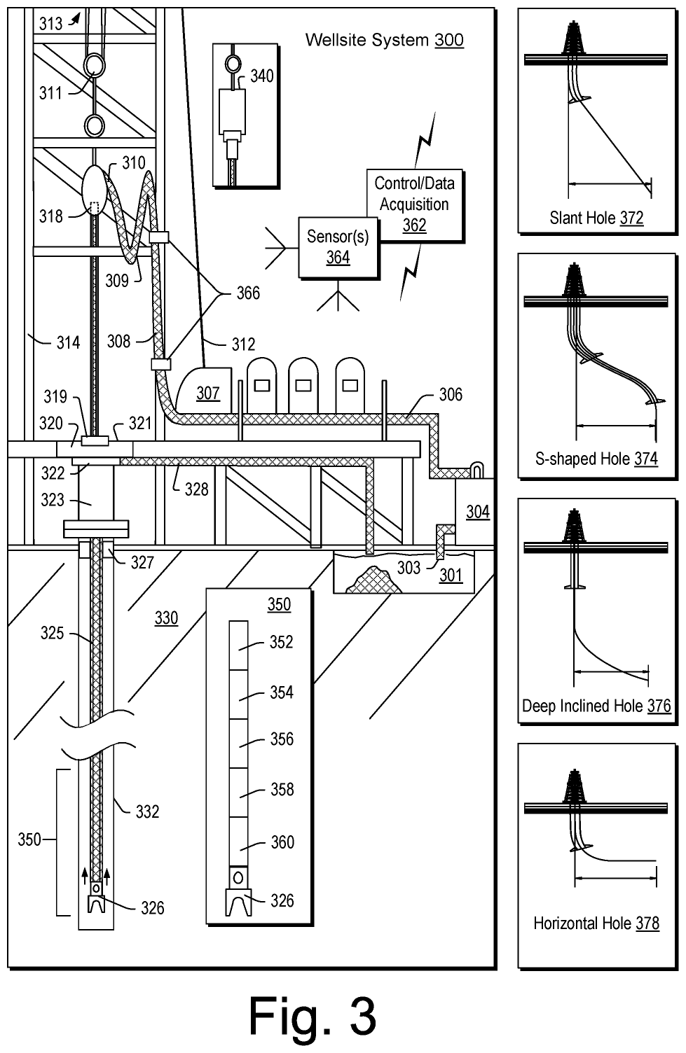

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud (e.g., and cuttings) may be returned to the mud tank 301, for example, for recirculation (e.g., with processing to remove cuttings, etc.).

The mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may be modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360, and the drill bit 326. Such components or modules may be referred to as tools where a drillstring can include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM can be determined or estimated as a sum of the SRPM and the mud motor RPM, assuming the SRPM and the mud motor RPM are in the same direction.

As an example, a PDM mud motor can operate in a so-called sliding mode, when the drillstring is not rotated from the surface. In such an example, a bit RPM can be determined or estimated based on the RPM of the mud motor.

An RSS can drill directionally where there is continuous rotation from surface equipment, which can alleviate the sliding of a steerable motor (e.g., a PDM). An RSS may be deployed when drilling directionally (e.g., deviated, horizontal, or extended-reach wells). An RSS can aim to minimize interaction with a borehole wall, which can help to preserve borehole quality. An RSS can aim to exert a relatively consistent side force akin to stabilizers that rotate with the drillstring or orient the bit in the desired direction while continuously rotating at the same number of rotations per minute as the drillstring.

The LWD module 354 may be housed in a suitable type of drill collar and can contain one or a plurality of selected types of logging tools. It will also be understood that more than one LWD and/or MWD module can be employed, for example, as represented by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 354 may include equipment for generating electrical power, for example, to power various components of the drillstring 325. As an example, the MWD tool 354 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform methods such as geosteering. As mentioned, a steerable system can be or include an RSS. As an example, a steerable system can include a PDM of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 300. As an example, a sensor or sensor may be at an offset wellsite where the wellsite system 300 and the offset wellsite are in a common field (e.g., oil and/or gas field).

As an example, one or more of the sensors 364 can be provided for tracking pipe, tracking movement of at least a portion of a drillstring, etc.

As an example, the system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus.

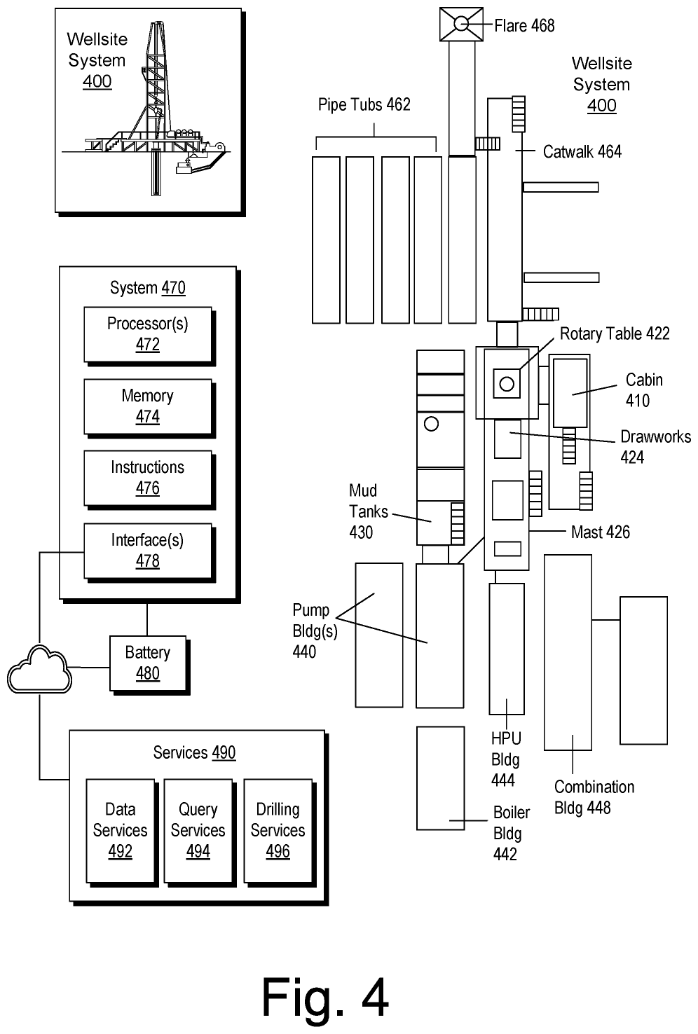

FIG. 4 shows an example of a wellsite system 400, specifically, FIG. 4 shows the wellsite system 400 in an approximate side view and an approximate plan view along with a block diagram of a system 470.

In the example of FIG. 4, the wellsite system 400 can include a cabin 410, a rotary table 422, drawworks 424, a mast 426 (e.g., optionally carrying a top drive, etc.), mud tanks 430 (e.g., with one or more pumps, one or more shakers, etc.), one or more pump buildings 440, a boiler building 442, an HPU building 444 (e.g., with a rig fuel tank, etc.), a combination building 448 (e.g., with one or more generators, etc.), pipe tubs 462, a catwalk 464, a flare 468, etc. Such equipment can include one or more associated functions and/or one or more associated operational risks, which may be risks as to time, resources, and/or humans.

As shown in the example of FIG. 4, the wellsite system 400 can include a system 470 that includes one or more processors 472, memory 474 operatively coupled to at least one of the one or more processors 472, instructions 476 that can be, for example, stored in the memory 474, and one or more interfaces 478. As an example, the system 470 can include one or more processor-readable media that include processor-executable instructions executable by at least one of the one or more processors 472 to cause the system 470 to control one or more aspects of the wellsite system 400. In such an example, the memory 474 can be or include the one or more processor-readable media where the processor-executable instructions can be or include instructions. As an example, a processor-readable medium can be a computer-readable storage medium that is not a signal and that is not a carrier wave.

FIG. 4 also shows a battery 480 that may be operatively coupled to the system 470, for example, to power the system 470. As an example, the battery 480 may be a back-up battery that operates when another power supply is unavailable for powering the system 470. As an example, the battery 480 may be operatively coupled to a network, which may be a cloud network. As an example, the battery 480 can include smart battery circuitry and may be operatively coupled to one or more pieces of equipment via a SMBus or other type of bus.

In the example of FIG. 4, services 490 are shown as being available, for example, via a cloud platform. Such services can include data services 492, query services 494 and drilling services 496. As an example, the services 490 may be part of a system such as the system 300 of FIG. 3.

As an example, the system 470 may be utilized to generate one or more rate of penetration drilling parameter values, which may, for example, be utilized to control one or more drilling operations.

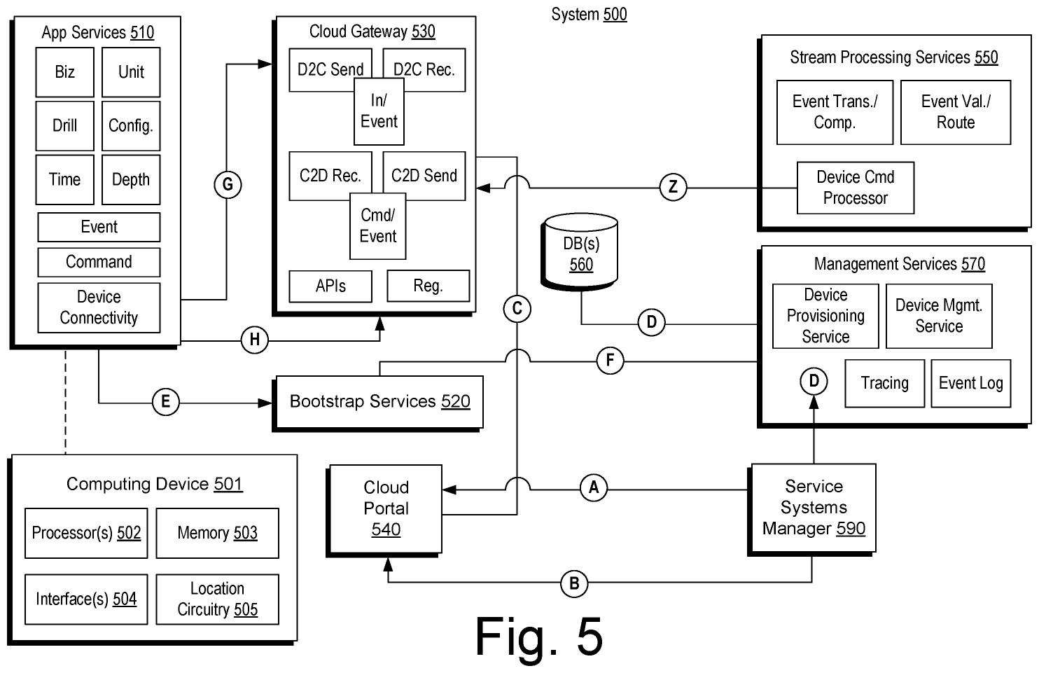

FIG. 5 shows an example of a system 500 that includes a computing device 501, an application services block 510, a bootstrap services block 520, a cloud gateway block 530, a cloud portal block 540, a stream processing services block 550, one or more databases 560, a management services block 570 and a service systems manager 590.

In the example of FIG. 5, the computing device 501 can include one or more processors 502, memory 503, one or more interfaces 504 and location circuitry 505 or, for example, one of the one or more interfaces 504 may be operatively coupled to location circuitry that can acquire local location information. For example, the computing device 501 can include GPS circuitry as location circuitry such that the approximate location of the computer device 501 can be determined. While GPS is mentioned (Global Positioning System), location circuitry may employ one or more types of locating techniques. For example, consider one or more of GLONASS, GALILEO, BeiDou-2, or another system (e.g., global navigation satellite system, “GNSS”). As an example, location circuitry may include cellular phone circuitry (e.g., LTE, 3 G, 4 G, etc.). As an example, location circuitry may include WiFi circuitry.

As an example, the application services block 510 can be implemented via instructions executable using the computing device 501. As an example, the computing device 501 may be at a wellsite and part of wellsite equipment. As an example, the computing device 501 may be a mobile computing device (e.g., tablet, laptop, etc.) or a desktop computing device that may be mobile, for example, as part of wellsite equipment (e.g., doghouse equipment, rig equipment, vehicle equipment, etc.).

As an example, the system 500 can include performing various actions. For example, the system 500 may include a token that is utilized as a security measure to assure that information (e.g., data) is associated with appropriate permission or permissions for transmission, storage, access, etc.

In the example of FIG. 5, various circles are shown with labels A to H. As an example, A can be a process where an administrator creates a shared access policy (e.g., manually, via an API, etc.); B can be a process for allocating a shared access key for a device identifier (e.g., a device ID), which may be performed manually, via an API, etc.); C can be a process for creating a “device” that can be registered in a device registry and for allocating a symmetric key; D can be a process for persisting metadata where such metadata may be associated with a wellsite identifier (e.g., a well ID) and where, for example, location information (e.g., GPS based information, etc.) may be associated with a device ID and a well ID; E can be a process where a bootstrap message passes that includes a device ID (e.g., a trusted platform module (TPM) chip ID that may be embedded within a device) and that includes a well ID and location information such that bootstrap services (e.g., of the bootstrap services block 520) can proceed to obtain shared access signature (SAS) key(s) to a cloud service endpoint for authorization; F can be a process for provisioning a device, for example, if not already provisioned, where, for example, the process can include returning device keys and endpoint; G can be a process for getting a SAS token using an identifier and a key; and H can be a process that includes being ready to send a message using device credentials. Also shown in FIG. 5 is a process for getting a token and issuing a command for a well identifier (see label Z).

As an example, Shared Access Signatures can be an authentication mechanism based on, for example, SHA-256 secure hashes, URIs, etc. As an example, SAS may be used by one or more Service Bus services. SAS can be implemented via a Shared Access Policy and a Shared Access Signature, which may be referred to as a token. As an example, for SAS applications using the AZURE .NET SDK with the Service Bus, .NET libraries can use SAS authorization through the SharedAccessSignatureTokenProvider class.

As an example, where a system gives an entity (e.g., a sender, a client, etc.) a SAS token, that entity will not have the key directly, and that entity cannot reverse the hash to obtain it. As such, there is control over what that entity can access and, for example, for how long access may exist. As an example, in SAS, for a change of the primary key in the policy, Shared Access Signatures created from it will be invalidated.

As an example, the system 500 of FIG. 5 can be implemented for provisioning of one or more pieces of equipment, which may be rig equipment, wireline equipment, production equipment, fracturing equipment, etc.

As an example, a method can include establishing an Internet of Things (IoT) hub or hubs. As an example, such a hub or hubs can include one or more device registries. In such an example, the hub or hubs may provide for storage of metadata associated with a device and, for example, a per-device authentication model. As an example, where location information indicates that a device (e.g., wellsite equipment, etc.) has been changed with respect to its location, a method can include revoking the device in a hub.

As an example, such an architecture utilized in a system such as, for example, the system 500, may include features of the AZURE architecture and/or one or more other cloud architectures. As an example, the cloud portal block 540 can include one or more features of an AZURE portal that can manage, mediate, etc. access to one or more services, data, connections, networks, devices, etc.

As an example, the system 500 can include a cloud computing platform and infrastructure, for example, for building, deploying, and managing applications and services (e.g., through a network of datacenters, etc.). As an example, such a cloud platform may provide PaaS and IaaS services and support one or more different programming languages, tools and frameworks, etc.

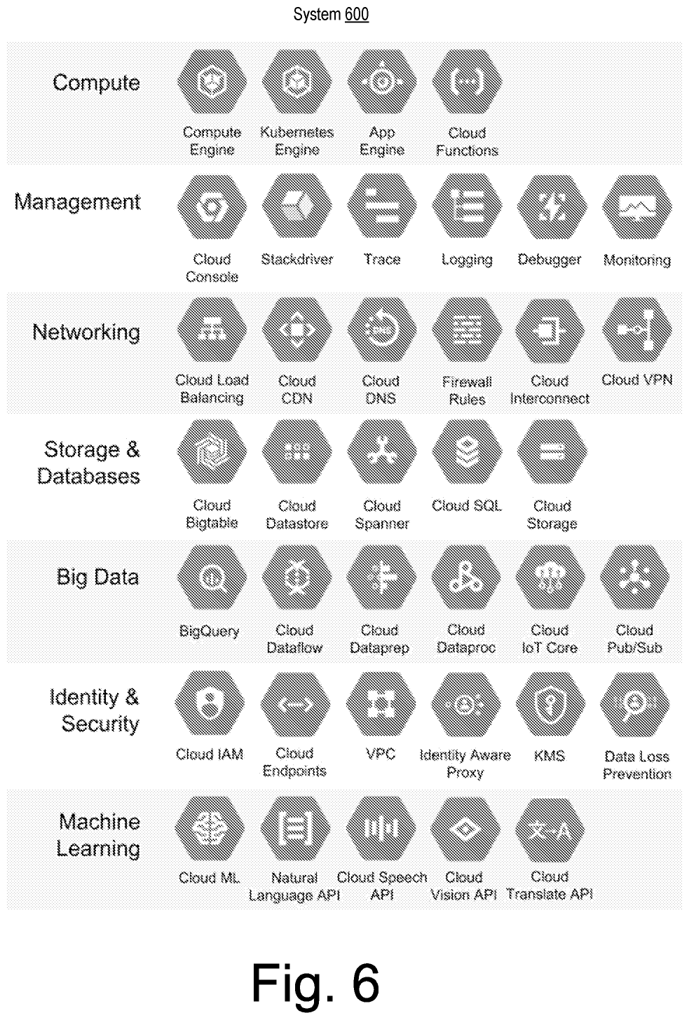

FIG. 6 shows an example of a system 600 that can be at least in part cloud-based. For example, the system 600 can be part of a cloud-based platform or cloud platform. As shown, the system 600 includes compute tools, management tools, networking tools, storage and database tools, large data tools, identity and security tools, and machine learning tools. As shown, the identity and security tools can include a key management service (KMS) tool. Key management can provide for management of cryptographic keys in a cryptosystem, which can include tasks associated with the generation, exchange, storage, use, crypto-shredding (destruction) and replacement of keys. It can include cryptographic protocol design, key servers, user procedures, and other relevant protocols. As an example, the system 300 can include features of one or more cloud platforms (e.g., GOOGLE CLOUD, AMAZON WEB SERVICES CLOUD, AZURE CLOUD, etc.). As an example, the DELFI cognitive exploration and production (E&P) environment may be implemented at least in part in a cloud platform that includes one or more features of the system 600.

In the GOOGLE CLOUD platform, when an application requests private data, the request is to be authorized by an authenticated entity that has access to the data, which can be part of an OAuth 2.0 flow. In various instances where an application is not demanding access to data, a system may utilize a server-centric OAuth 2.0 flow based on a service account. OAuth 2.0 is an industry-standard protocol for authorization. OAuth 2.0 provides specific authorization flows for web applications, desktop applications, mobile phones, living room devices, etc.

A request an application sends to a cloud storage JSON application programming interface (API) that demands authorization is to identify the application to the cloud platform, which may occur in using an OAuth 2.0 token (which also authorizes the request) and/or using the application's API key.

As an example, if a request demands authorization (such as a request for private data), then the application is to provide an OAuth 2.0 token with the request; noting that the application may also provide the API key. As an example, if a request is not demanding authorization (e.g., a request for public data), then no identification is demanded; however, the application may still provide the API key, an OAuth 2.0 token, or both. An application in the GOOGLE CLOUD platform can use OAuth 2.0 to authorize requests.

OAuth 2.0 provides for tokens and token management. For example, consider token introspection (see, e.g., RFC 7662), to determine the active state and meta-information of a token, token revocation (see, e.g., RFC 7009), to signal that a previously obtained token is no longer needed, and JAVASCRIPT object notation (JSON) Web Token (JWT) (see, e.g., RFC 7519).

The token introspection extension defines a mechanism for resource servers to obtain information about access tokens. With this specification, resource servers can check the validity of access tokens, and find out other information such as which user and which scopes are associated with the token.

The token revocation extension defines a mechanism for clients to indicate to the authorization server that an access token is no longer needed. This can be used to enable a “log out” feature in clients, allowing the authorization server to clean up security credentials associated with the authorization.

As an example, JWT can provide a way to encode claims in a JSON document and/or object that is then signed. JWTs can be used as OAuth 2.0 Bearer Tokens to encode relevant parts of an access token into the access token itself instead of having to store them in a database.

Self-encoded tokens can provide a way to not store tokens in a database by encoding information in the token string itself. In such an example, an API server may be able to verify access tokens without doing a database lookup on each API request, making the API more scalable.

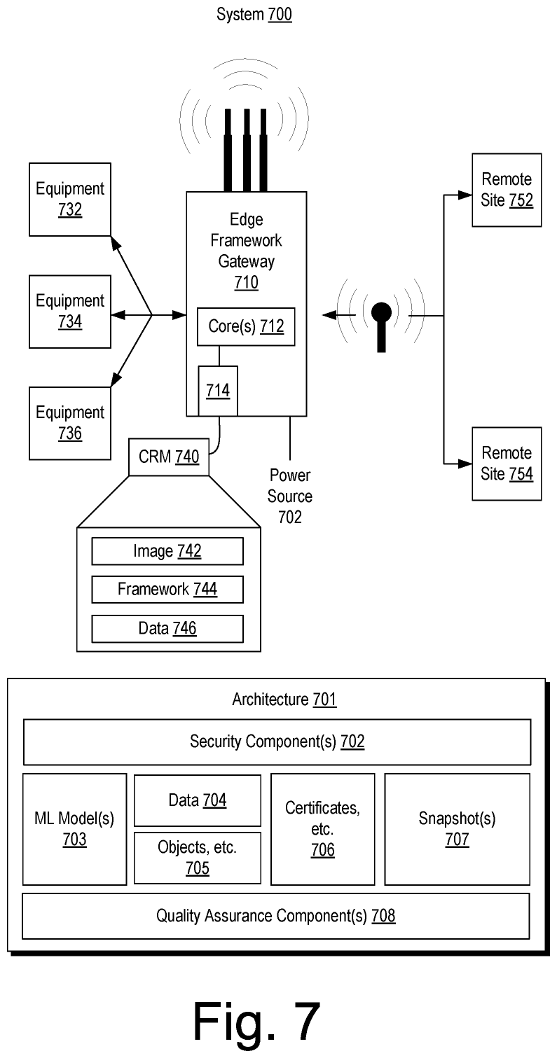

FIG. 7 shows an example of a system 700 and an example of an architecture 701. As shown, the architecture 701 can provide for one or more security components 702, one or more machine learning models 703, data 704, objects, etc. 705, certificates, etc. 706, snapshots, etc. 707, and one or more quality assurance components 708. As an example, a quality assurance component may be associated with one or more types of implementation strategies. For example, consider a field device that may receive instructions as to how to implement a deployed machine learning model, etc.

The architecture 701 can include a result interface where an output result can be a control trigger that can call for an action or actions by a piece or pieces of equipment.

As shown, the system 700 can include a power source 702 (e.g., solar, generator, battery, grid, etc.) that can provide power to an edge framework gateway 710 that can include one or more computing cores 712 and one or more media interfaces 714 that can, for example, receive a computer-readable medium 740 that may include one or more data structures such as an image 742, a framework 744 and data 746. In such an example, the image 742 may be an operating system image that can cause one or more of the one or more cores 712 to establish an operating system environment that is suitable for execution of one or more applications. For example, the framework 744 may be an application suitable for execution in an established operating system in the edge framework gateway 710.

In the example of FIG. 7, the edge framework gateway 710 (“EF”) can include one or more types of interfaces suitable for receipt and/or transmission of information. For example, consider one or more wireless interfaces that may provide for local communications at a site such as to one or more pieces of local equipment 732, 734 and 736 and/or remote communications to one or more remote sites 752 and 754.

As an example, the EF 710 may be installed at a site that is some distance from a city, a town, etc. In such an example, the EF 710 may be accessible via a satellite communication network and/or one or more networks.

A communications satellite is an artificial satellite that relays and amplifies radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite.

High frequency radio waves used for telecommunications links travel by line-of-sight, which may be obstructed by the curve of the Earth. Communications satellites can relay signal around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency.

As shown in the example of FIG. 7, the EF 710 may be deployed where it can operate locally with one or more pieces of equipment 732, 734, 736, etc., which may be for purposes of control. As an example, the EF 710 may include switching and/or communication capabilities, for example, for information transmission between equipment, etc.

As desired, from time to time, communication may occur between the EF 710 and one or more remote sites 752, 754, etc., which may be via satellite communication where latency and costs are tolerable. As an example, the CRM 740 may be a removable drive that can be brought to a site via one or more modes of transport. For example, consider an air drop, a human via helicopter, plane or boat, etc.

As to an air drop, consider dropping an electronic device that can be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF 710. Such an approach can provide for local control where one or more humans may or may not be present at the site. As an example, an autonomous and/or human controllable vehicle at a site may help to locate an electronic device and help to download its payload to an EF such as the EF 710. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As to drones, consider a drone that includes one or more features of one or more of the following types of drones DJI Matrice 210 RTK, DJI Matrice 600 PRO, Elistair Orion Tethered Drone, Freefly ALTA 8, GT Aeronautics GT380, Skydio 2, Sensefly eBee X, Skyfront Perimeter 8, Vantage Robotics Snap, Viper Vantage and Yuneec H920 Plus Tornado. The DJI Matrice 210 RTK can have a takeoff weight of 6.2 g (include battery and max 1.2 kg payload), a maximum airspeed of 13-30 m/s (30-70 mph), a range of 500 m-1 km with standard radio/video though it may be integrated with other systems for further range from base, a flight time of 15-30 minutes (e.g., depending on battery and payload choices, etc.). As an example, a gateway may be a mobile gateway that includes one or more features of a drone and/or that can be a payload of a drone.

As shown in FIG. 7, an EF may execute within a gateway such as, for example, an AGORA gateway (e.g., consider one or more processors, memory, etc., which may be deployed as a “box” that can be locally powered and that can communicate locally with other equipment via one or more interfaces). As an example, one or more pieces of equipment may include computational resources that can be akin to those of an AGORA gateway or more or less than those of an AGORA gateway. As an example, an AGORA gateway may be a network device.

As an example, a gateway can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm).

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke valve, a pump, etc.).

As an example, a gateway may include hardware (e.g. circuitry) that can provide for operation of a drone. As an example, a gateway may be a drone controller and a controller for other equipment where the drone controller can position the gateway (e.g., via drone flight features, etc.) such that the gateway can control the other equipment.

As an example, a mobile gateway may be operable in one or more safety modes. For example, if conditions change, a mobile gateway may be able to issue one or more safety instructions and then fly away to protect the mobile gateway. In such an example, the mobile gateway and data therein (e.g., a black box) may be kept safe. Such an approach may be utilized, for example, where an operational issue arises, where a site is invaded by one or more intruders, etc. For example, consider an intruder that aims to interfere with equipment, which may be to damage equipment, alter the equipment, steal fluid, etc. In such an example, a mobile gateway may detect and/or receive a detection signal and place equipment in a suitable state and then fly away to protect itself. Where an intruder departs, the mobile gateway may return and run an assessment to determine whether a return to operation is possible or not. As mentioned, where a gateway include satellite communication circuitry, a gateway may issue one or more signals such as one or more distress or SOS types of signals that may alert as to a threat, which may be imminent and/or in progress.

As an example, a gateway may include one or more cameras such that the gateway can record conditions. For example, consider a motion detection camera that can detect the presence of an object. In such an example, an image of the object and/or an analysis (e.g., image recognition) signal thereof may be transmitted (e.g., via a satellite communication link) such that a risk may be assessed at a site that is distant from the gateway.

As an example, a gateway may include one or more accelerometers, gyroscopes, etc. As an example, a gateway may include circuitry that can perform seismic sensing that indicates ground movements. Such circuitry may be suitable for detecting and recording equipment movements and/or movement of the gateway itself.

As explained, a gateway can include features that enhance its operation at a remote site that may be distant from a city, a town, etc., such that travel to the site and/or communication with equipment at the site is problematic and/or costly. As explained, a gateway can include an operating system and memory that can store one or more types of applications that may be executable in an operating system environment. Such applications can include one or more security applications, one or more control applications, one or more simulation applications, etc.

As an example, various types of data may be available, for example, consider real-time data from equipment and ad hoc data. In various examples, data from sources connected to a gateway may be real-time, ad hoc data, sporadic data, etc. As an example, lab test data may be available that can be used to fine tune one or more models (e.g., locally, etc.). As an example, data from a framework such as the AVOCET framework may be utilized where results and/or data thereof can be sent to the edge. As an example, one or more types of ad hoc data may be stored in a database and sent to the edge.

As explained, various systems may operate in a local manner, optionally without access to a network such as the Internet. For example, a site may be relatively remote where satellite communication exists as a main mode of communication, which may be costly and/or low bandwidth. In such scenarios, security may resort to local features rather than a remote feature such as a remote authentication server.

An authentication server can provide a network service that applications use to authenticate credentials, which may be or include account names and passwords of users (e.g., human and/or machine). When a client submits a valid credential or credentials to an authentication server, the authentication server can generate a cryptographic ticket that the client can subsequently use to access one or more services.

Authentication can be used as a basis for authorization, which is the determination whether a privilege may be granted to a particular user (e.g., human and/or machine), which may aim to keep information from becoming known to non-participants, and non-repudiation, which is the inability to deny having done something that was authorized to be done based on the authentication.

In the field, a scenario can arise where two or more computational devices are to be paired for communication (e.g., uni- and/or bi-directional transmissions, etc.) via one or more secure channels without having to access the Internet. For example, consider a scenario where a link to the Internet is unavailable, is of too low a bandwidth, is lacking security, is lacking stability, etc. In such a scenario, a local technique may be employed to establish one or more secure channels.

As explained, a framework such as an edge framework (EF) can utilize one or more machine learning models (ML models). Managing deployment of EF ML models can present challenges, particularly where types of equipment, processes, locations, etc., can differ from site to site and/or at a particular site. As explained, an EF may be part of an Internet of Things (IoT) system or may be a locally networked system with or without access to the Internet. As an example, a method can include operationalizing machine learning in edge applications (IoT, etc.).

Ranging from recommending products to autonomously driving around town, machine learning is rapidly transforming processes; however, data scientists face challenges deploying models. These challenges are further magnified when the host is a device with limited resources and/or limited connectivity. As an example, a system can provide for timely deployment of edge optimized models, for example, in a manner that may leverage existing infrastructure, which may or may not demand access to cloud resources.

As explained, the building of data science-based solutions can provide for delivery of actionable information (e.g., recommendations, control, monitoring, etc.). Machine learning models can use data to solve complex problems, for example, by discovering hidden patterns that may be difficult to find with simple analytic models.

Various different techniques and algorithms used for building machine learning models can share common workflows for training and validating models, for example, using existing data and performing inferences on new data. Data scientists are accustomed to working with model training and validation frameworks that suits their demands but the biggest challenge they face is how to deploy models for processes and how to monitor and update models after deployment.

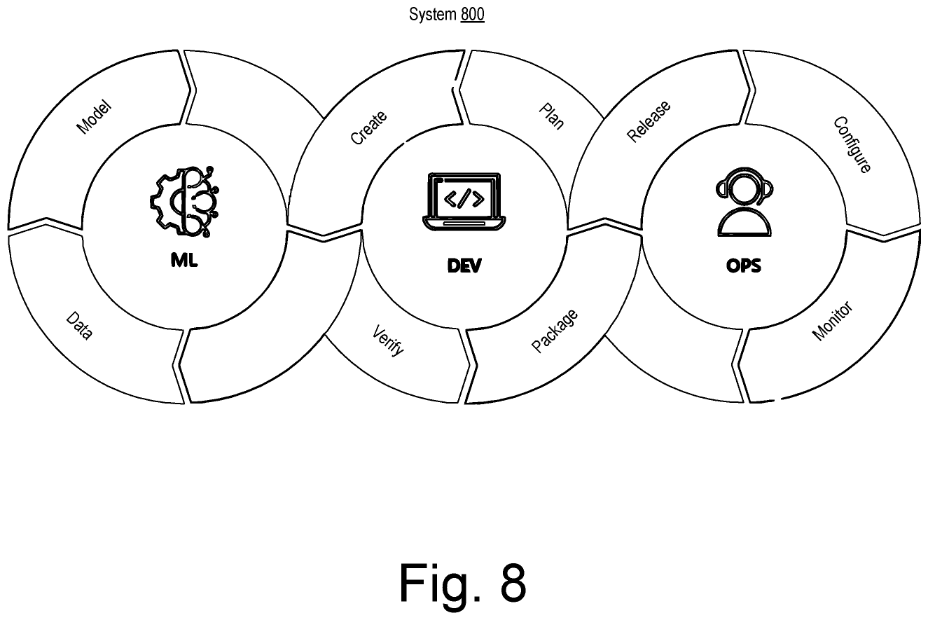

FIG. 8 shows an example of a system 800, which may be referred to as a ML models lifecycle. As shown, the system 800 can include a set of practices that aims to streamline access to training data and a simplified workflow for training, building, deploying, monitoring, and maintaining of ML models in production reliably and efficiently. Operationalization of ML models means more than just streamlining the deployment process, it also includes measuring performance and automated retraining of models after being exposed to a large set of data.

As an example, a system can provide for managing lifecycle ML model development, deployment, etc. Such a system may operate in a manner that uses existing infrastructure such as, for example, field components such as the aforementioned AGORA box, one or more types of programmable logic controllers (PLCs), etc. Such field components may have Internet communication or not. As explained, fields can differ, field operations can differ, etc., which can add to heterogeneity of system demands. Given such heterogeneity, a system may operate using one or more commonalities that may be driven by one or more factors such as, for example, limited communication, limited power, limited human accessibility, etc. As an example, a focus on such one or more commonalities may also aim to alleviate data scientist demands. For example, consider an approach that simplifies or reduces a data scientist's set of skills as to non-data science tasks and provides for deployment of lightweight code in a reliable and robust manner. In such an example, monitoring may be performed in a manner that can return meaningful results to data scientists, which, in turn, can inform model building (e.g., type of model, model building, model training, model re-training, etc.).

As an example, a system can include a repository of models and data where a data scientist may readily select a model and identify data suitable for use in training, testing, etc. For example, consider a cloud and edge infrastructure that allows data scientists to identify historical data to train models, stage trained models for deployment at scale, monitor models while running in production, and retrain when performance deteriorates. Such a system may also provide a containerized runtime environment where a deployable unit is reduced to, for example, a model and metadata, for example, without demanding code from a data scientist. In such an example, a system can provide for optimization of a model for resource constrained edge devices and seamlessly bind to edge data streams using metadata.

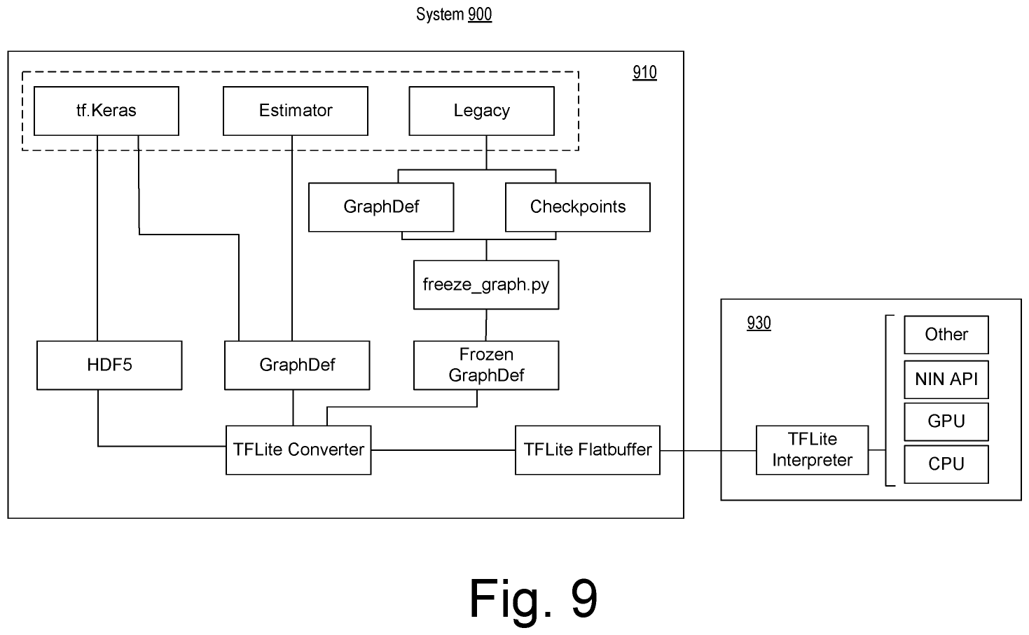

FIG. 9 shows an example of a system 900 that includes a client-server architecture where a server 910 can provide a client 930 with code that can be executed and/or interpreted using client-based resources (e.g., CPU, GPU, APIs, etc.).

The system 900 includes various features of the TENSORFLOW LITE (TFL) system. As shown in FIG. 9, when a model is fixed, it can be saved in a format containing both of its graph and weights so that the model can be frozen to a .tflite file with its graph and weights where such a format can be recognized by a client application (e.g., proprietary OS, ANDROID OS, LINUX OS, iOS, WINDOWS OS, etc.). During the process to freeze the model, variables used in training can be converted to constants.

As an example, in the TFL system, a method can include generating a model where the model can be represented in an efficient portable format known as FlatBuffers (e.g., using the .tflite file extension). Such a format can be compared to the protocol buffer model format where the FlatBuffers provides reduced size (e.g., small code footprint) and faster inference (e.g., data can be directly accessed without an extra parsing/unpacking step), which can allow for execution efficiently on devices with limited compute and/or memory resources.

As an example, a model can optionally include metadata that can have a human-readable model description and machine-readable data for automatic generation of pre- and post-processing pipelines during on-device inference.

As an example, model generation can be via an existing model (e.g., with or without metadata) or via creating a model (e.g., using a model maker). As an example, a converter can be utilized to convert a model into a lighter-weight model. For example, consider the TFLite converter as shown in the server 910 of FIG. 9. During conversion, one or more optimizations may be applied, for example, consider quantization to reduce model size and latency with minimal or no loss in accuracy.

As an example, a method can include running inference. For example, in the TFL system, inference refers to the process of executing a TFL model on-device to make predictions based on input data. Inference may be run in one or more ways, for example, based on the model type. For models without metadata, a TFL interpreter API may be utilized (e.g., supported on multiple platforms and languages such as JAVA, SWIFT, C++, PYTHON, etc.). A local framework may provide for interpretation, execution, etc., of instructions, for example, to provide a local inference engine (e.g., to provide inferences responsive to input, etc.). For models with metadata, an approach can leverage the out-of-box APIs using the TFL Task Library or by building one or more custom inference pipelines with the TFL Support Library. On ANDROID OS devices, a developer may automatically generate code wrappers using the ANDROID STUDIO ML Model Binding or the TFL Code Generator (e.g., supported on JAVA (ANDROID OS), SWIFT (iOS), C++, etc.

As an example, various devices may provide for hardware acceleration. For example, consider using a GPU delegate, the NNAPI Delegate, the Hexagon Delegate, the Core ML Delegate, etc. As an example, a device may include an embedded LINUX OS (e.g., RASPBERRY PI and CORAL devices with edge TPU, or C++ build instructions for ARM processors, etc.). As to microcontrollers, a TFL for microcontrollers library for microcontrollers and DSPs may be utilized, for example, where a device may include as little as a few kilobytes of memory.

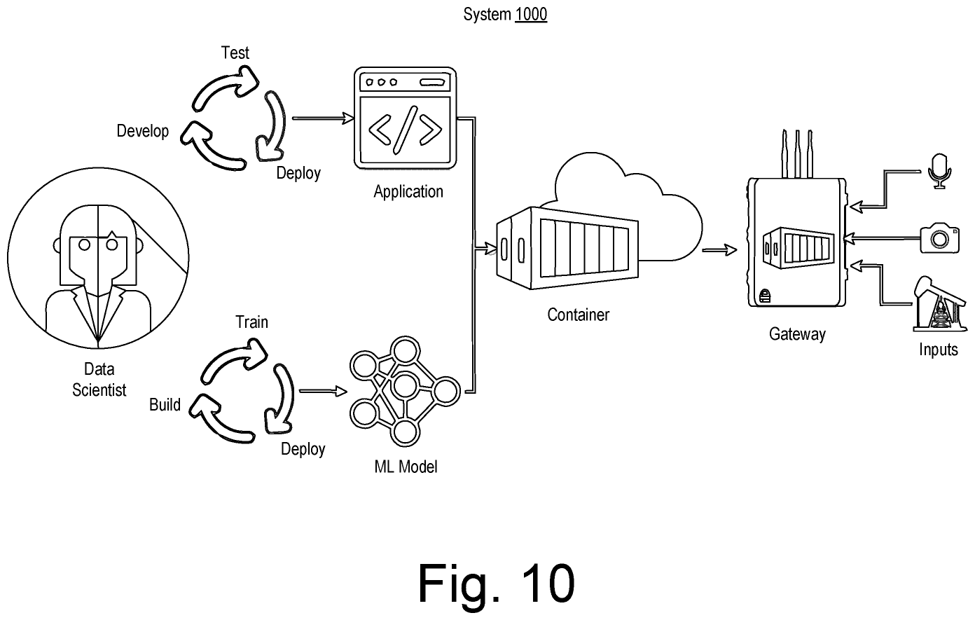

FIG. 10 shows an example of a system 1000 where a data scientist develops an application and builds a ML model, both of which form a container where the container is deployed to a gateway that can execute the application and ML model, which may operate on input(s) to generate output. In such an example, the container is larger in size than the ML model itself. Further, at the gateway, execution of an existing application is generally halted such that the new application can be loaded and executed. Such an approach results in application downtime where input may be discarded, buffered, etc., or otherwise become aged, and where output can be unavailable. Such an approach can impact a process, for example, a process may be put in a wait state that waits until the update occurs at the gateway for the received container.

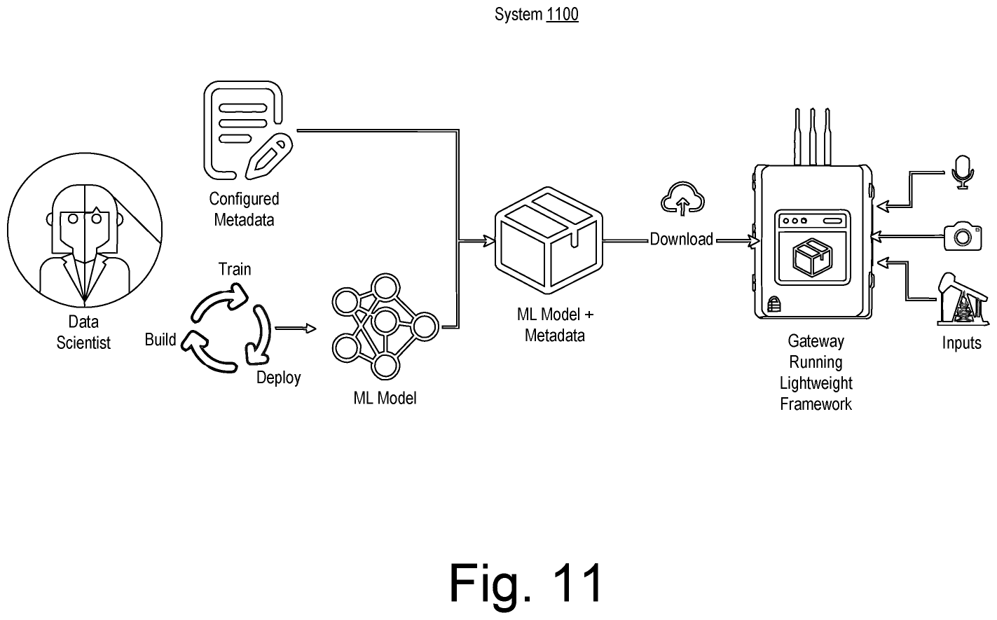

FIG. 11 shows an example of a system 1100 where a data scientist configures metadata and builds a ML model, both of which can form a rather lightweight data structure that can be transmitted to a gateway that can execute a ML model, for example, using a lightweight framework. In the example of FIG. 11, the system 1100 demands less from the data scientist when compared to the example of FIG. 10. In the example of FIG. 11, the data scientist can be more effective as being concerned with metadata configuring and ML model building rather than being concerned with an entire application.

As an example, the system 1100 may utilize one or more features of a system such as, for example, the TFL system. For example, the system 1100 may utilize one or more of the features of the system 900 of FIG. 9. For example, consider the ML model and metadata as being in the form of a. tflite file, etc.

In the example of FIG. 11, the payload downloaded to the gateway may be sufficiently small for deployment via low bandwidth and high latency links with compression enabled (e.g., satellite, etc.). For example, the size may be small enough to be downloaded in less than a few minutes and with minimal resource cost. As an example, the approach of FIG. 11 may be implemented in a manner where downtime is minimal at the gateway. For example, as an entire application is not included in the payload to replace an entire application at the gateway, the gateway may operate with more uptime. For example, downtime may be minimized to the order of seconds.

As an example, a method can include running two ML models simultaneously at a field device. In such an example, an existing ML model (e.g., old model) may generate output for a process and a new ML model may generate output that can be compared to the output for the process of the old ML model. In such an example, the comparison may aim to determine whether the new ML model is able to perform adequately where, for example, if the new ML model is not able to perform adequately, the field device may continue use of the old model. Further, information as to the comparison, performance, etc., may be transmitted to a remote location where, for example, a data scientist may assess the information to improve ML modeling and/or metadata configuring.

As an example, a method can include transmitting information to a system where the system may trigger one or more actions based at least in part on the information. For example, consider one or more actions with respect to one or more other devices, one or more other field sites, etc. For example, information may indicate a ML model and/or metadata configuration vulnerability that may occur at one or more other devices, sites, etc. In such an example, the information may be an alert that indicates attention is warranted to one or more processes controlled by, monitored by, etc., a ML model.

In the example of FIG. 11, the gateway device can be a field site gateway device that may be operatively coupled to one or more pieces of equipment (e.g., one or more field devices). As mentioned, such a device can include a runtime engine such as a runtime engine of an edge framework (EF). As explained, such a device can include features of the AGORA gateway and, for example, can include a Base Module as an IoT edge optimized engine, which may provide for improved start-up time and decreased memory usage. As an example, a framework such as the REACT framework may be utilized, which may utilize a platform's native capabilities. For example, consider use of JavaScript to access a platform's APIs as well as to describe the appearance and behavior of one or more interfaces, etc.

As an example, a field device can include one or more features of one or more AGORA products (e.g., AGORACORE, AGORAVISION, AGORACONNECT, etc.). AGORACORE extensible middleware manages remote gateway updates and leverages containerized microservices to integrate edge applications onto an AGORA gateway device and provides the AGORA software development kit (SDK). AGORAVISION provides a real-time data visualization interface that can provide a view of an edge ecosystem (e.g., accessible via mobile, desktop, etc.). AGORACONNECT provides for communication services, for example, to transmit edge information to the cloud, etc., where it may be contextualized, organized, visualized and transformed into insights that can be used to optimize operations.

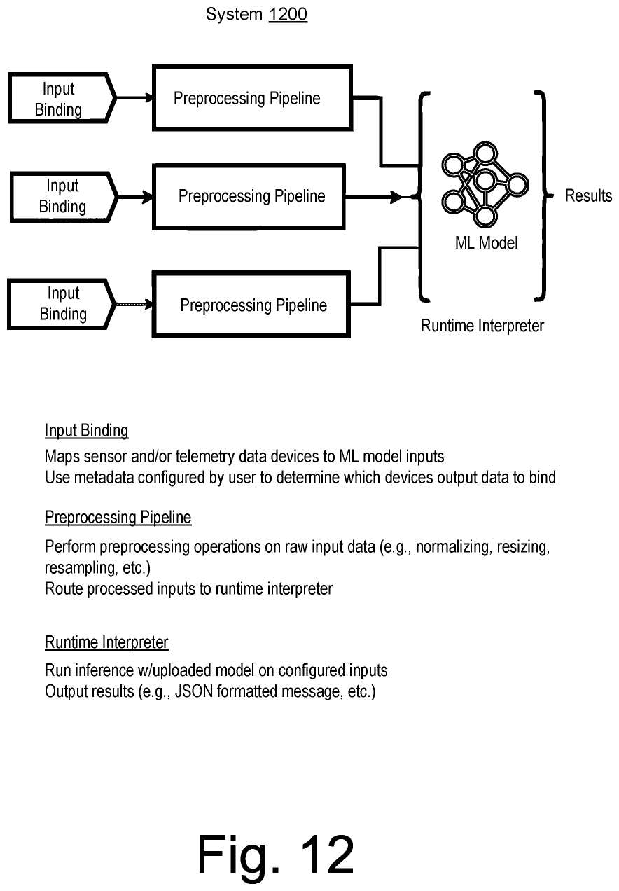

FIG. 12 shows an example of a system 1200 that includes various input binding processes, preprocessing pipeline processes and a ML model executable using a runtime interpreter to generate results (e.g., output). In the example of FIG. 12, the input binding processes may be associated with various types of input (e.g., sensors, etc.).

As an example, input binding can include one or more maps for sensor and/or telemetry data devices to ML model inputs. As an example, such an approach may utilize metadata configured to determine which devices output data to bind. As an example, a preprocessing pipeline can include performing preprocessing operations on raw input data (e.g., normalizing, resizing, resampling, etc.) and, for example, routing processed inputs to an appropriate runtime interpreter. As to the runtime interpreter, it may run inferences with an uploaded ML model on configured inputs and, for example, output results (e.g., JSON formatted message, etc.).

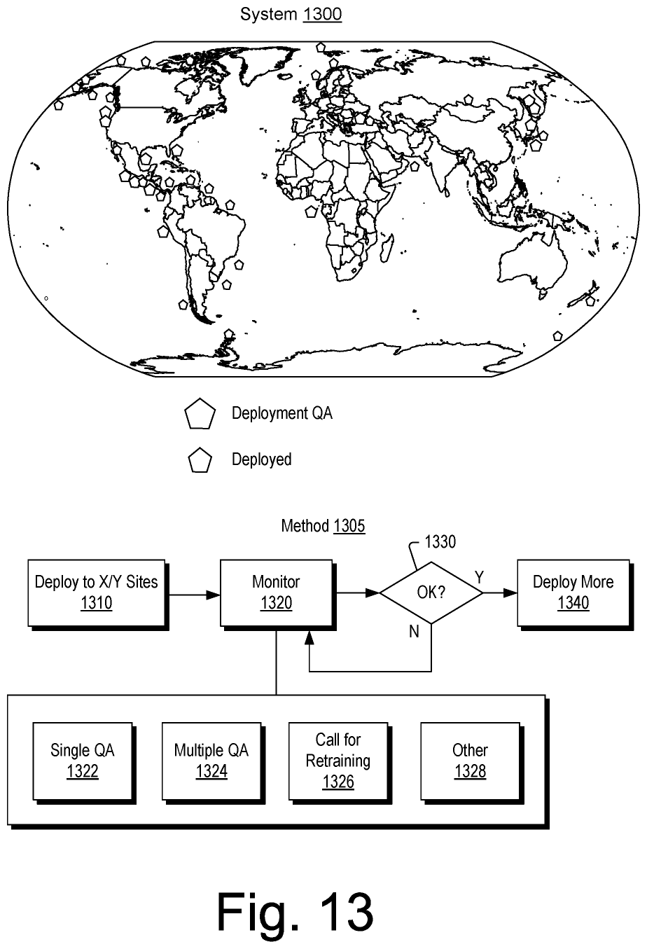

FIG. 13 shows an example of a system 1300 that includes a graphical user interface with a map that indicates locations of deployed ML models and deployment QA processes (e.g., assessing quality of a deployed model, etc.).

FIG. 13 also shows an example of a method 1305 that includes a deployment block 1310 for deploying to X of Y sites (e.g., devices, etc.), a monitor block 1320 for monitoring deployed ML models, a decision block 1330 for deciding whether a deployed ML model is performing acceptably (e.g., “OK”) and a deployment block 1340 for deploying more ML models (e.g., up to Y or less than Y). In such an example, the method 1305 can provide for phased rollout (e.g., deployment) of ML models at various sites.

As shown in FIG. 13, the monitor block 1320 can include various components such as, for example, a single QA component 1322, a multiple QA component 1324, a call for retraining component 1326, and one or more other components 1328. In such an example, the monitor block 1320 may perform one or more types of assessments on one or more ML models (e.g., and/or metadata) to help decide what action may be appropriate for large scale operations that utilize ML models.

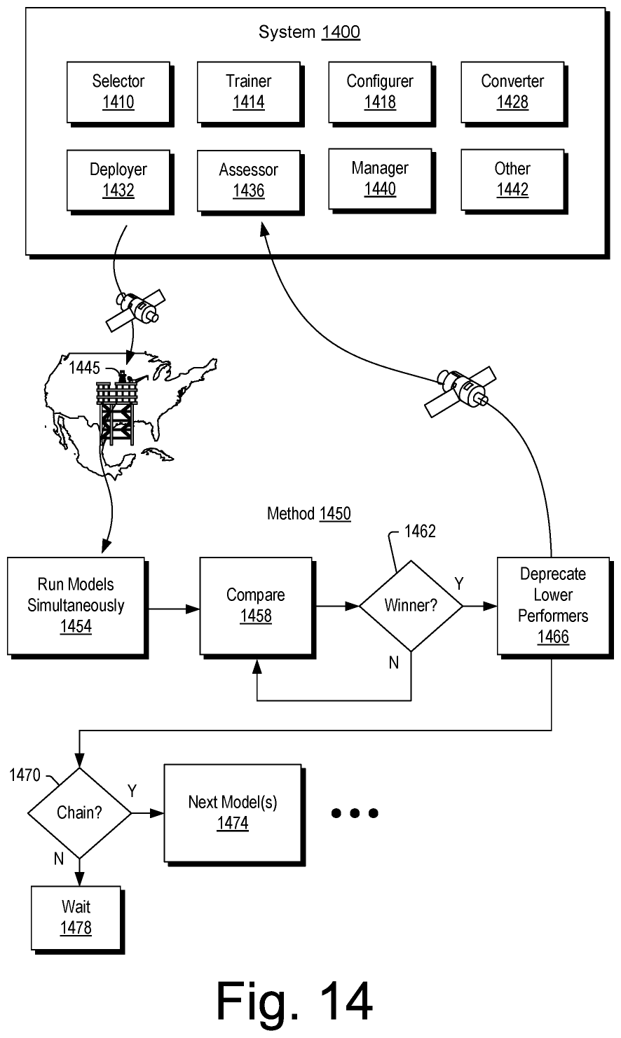

FIG. 14 shows an example of a system 1400 and an example of a method 1450. As shown, the system 1400 can include a selector 1410, a trainer 1414, a configurer 1418, a converter 1428, a deployer 1432, an assessor 1436, a manager 1440 and one or more other components 1442. The system 1400 can be suitable to handle various tasks for field devices at various sites. For example, consider a field device 1445 at an offshore site that can receive ML models output by the system 1400.

FIG. 14 shows an example of a method 1450 that may be run by the field device 1445. As shown, the method 1450 can include a run block 1454 for running ML models simultaneously on a device, a comparison block 1458 for comparing the ML models as run simultaneously, a decision block 1462 for deciding if a “winner” exists and a deprecation block 1466 for deprecating lower performers. In such an example, multiple ML models can be assessed in the field to decide as to which of the multiple ML models is to be utilized for a period of time, certain circumstances, etc.

The method 1450 also shows an example of one or more chain approach actions. For example, consider a decision block 1470 that decides whether the model implemented (e.g., the winner) is part of a managed chain approach to rollout at a field site. Where the decision block 1470 decides “yes”, the method 1450 can continue to a next block 1474 for implementation of one or more other ML models that may be part of a chain, otherwise, for example, per a “no” branch, the method 1450 may enter a wait block 1478 that waits for a trigger, etc., for example, to recommence the method 1450 at the run block 1454.

As explained, a system can include various components for handling tasks related to various types of ML models at various sites. In the example of FIG. 14, the selector 1410 can provide for selection of one or more ML models (e.g., from a repository, etc.), the trainer 1414 can provide for training of one or more ML models, the configurer 1418 can provide for configuring metadata (e.g., for inputs, outputs, etc.), the converter 1428 can provide for converting one or more ML models (e.g., trained, etc.) to a format suitable for transmission to a field device, the deployer 1432 can provide for deployment of one or more ML models to one or more field devices at one or more locations (e.g., via one or more communication routes, etc.), the assessor 1436 can provide for assessing performance and/or one or more other aspects of a ML model as may be deployed at a field site and the manager 1440 can provide for management of various operations of the system 1400 such as, for example, scheduling, selecting, training, converting, deploying, assessing, etc. For example, responsive to an assessment of the assessor 1436, the manager 1440 may call for training per the trainer 1414, which may include re-training a ML model based on information acquired from field implementation, etc.

In the example of FIG. 14, the deprecation block 1466 can provide information via one or more communication routes to the system 1400. For example, it may provide information as to what ML models and/or metadata configurations did not “win”, optionally along with performance data (e.g., input data, output data, etc.). Such an approach can help the system 1400 determine improvements, strategies, etc.

As explained with respect to FIG. 13, field sites can exist around the world. For example, consider a supplier of field devices that can ship and operate such devices at various locations where conditions may be the same and/or may differ. In such an example, where conditions are the same, the system 1400 can deploy the same ML model to each field device and may do so at the same time or in a phased manner, as explained with respect to the method 1305 of FIG. 13. As explained with respect to the method 1450 of FIG. 14, the system 1400 may deploy multiple ML models to one or more field devices to allow the one or more field devices to determine a winner or winners.

As an example, the system 1400 can include one or more digital twins, digital avatars, virtual machines, etc., of equipment, frameworks, etc. For example, consider a digital representation of the edge framework gate 710 of FIG. 7 and/or one or more pieces of equipment as in one or more of FIGS. 1, 2, 3 and 4. As an example, a digital representation may be operatively coupled to a simulator, a historical database, real time data, etc. As an example, the system 1400 can train, refine, test, etc., one or more ML models using a digital representation of equipment. As an example, output from a ML model can be compared to actual output from one or more pieces of field equipment. Such an approach may aim to refine a digital representation, a ML model, field equipment and/or an implementation strategy.

As an example, a phased approach may provide for insights such that if a ML model fails, a rollback can be performed at the field devices where it had been deployed. Such an approach can help to maintain uptime at sites until an adequate ML model is deployed for field device members of a phase. Once a suitable ML model is deployed, a next phase may commence for deployment of that ML model to other field devices that may be at the same or at other sites. As to a multiple ML model approach, it can help to make deployment more robust with a higher chance of a suitable ML model being deployed. In either instance, noting that a combined phased and multiple ML model approach may be utilized, information can be gleaned about ML model performance that can help making operations at scale more effective.

As mentioned, an “at-scale” system may handle heterogeneous field devices. For example, the system 1400 can handle operations associated for selecting, training, converting, deploying, etc., ML models and/or metadata for field devices that may have different capabilities, features, communication routes, etc. For example, a site may include field devices with different operating systems and/or a site may include a gateway that is in communication with different field devices that may be end devices. In such an example, the system 1400 can provide for appropriate conversion (e.g., via the converter 1428, etc.) to assure compatibility of ML models with respective field devices, optionally via one or more files that may be received by a field site gateway that is responsible for directing ML models and/or metadata of the files to appropriate field devices. In such an approach, the system 1400 may provide the field site gateway with a deployment file that controls local deployment to the field devices. For example, consider a deployment file that controls the order of deployment such that one field device receives a ML model before another field device receives a ML model (e.g., different, same, etc.).

As to managing field deployments, the manager 1440 of the system 1400 can include local information as to what field devices are at a site and how such field devices may interoperate and/or impact a process. For example, a field sensor may be a source of data to another field device that may output a control signal. In such an example, to stably update the ML models at the site, the sensor ML model may be updated first and, for example, assessed for performance (e.g., quality assurance, etc.). In such an example, the deployment file may indicate that the field site gateway is to wait for such a signal before deploying a ML model to the other field device that can output a control signal (e.g., based at least in part on output of the sensor as may be processed by the ML model at the sensor). Such an approach can help to assure that the sensor is stable before updating the field device that operates as a controller.

As shown in FIGS. 1, 2, 3, 4, etc., various types of equipment can be at a site where one or more pieces of equipment can include a runtime engine for a ML model or ML models. A scenario may be quite complex and, if deployment is not managed appropriately, substantial downtime (e.g., non-productive time), risks, etc., may occur. As explained with respect to the edge framework gateway 710 of FIG. 7, it may provide for implementation of one or more ML models that may receive information from and/or interact with one or more of the pieces of equipment 732, 734 and 736; noting that one or more of the one or more pieces of equipment 732, 734 and 736 may include capabilities sufficient for ML model implementation.

As an example, a field site gateway may provide for ML model implementation in a local network that includes multiple field devices. In such an example, as mentioned, a deployment file or other deployment instructions may be provided from a system such as, for example, the system 1400 of FIG. 14.

As an example, the system 1400 can include one or more features of the TIBCO NIMBUS framework for process documentation. Such a framework can provide for presenting an easy-to-understand visualization of how people, processes, and systems interact. Such a framework can help enable communication and simplification of processes to improve operations. As an example, the system 1400 can include one or more cloud implemented features. For example, the system 1400 may be substantially implemented using a cloud platform or cloud platforms or, for example, it may be implemented as an on-premises installation (e.g., or a combination of cloud and on-premises).

As explained, a single field site can be complex such that management of multiple field sites becomes quite complex. As an example, the system 1400 can manage such complexities. For example, consider management of automated activities and processes and/or manual activities and processes. As an example, a process may be a mixture of manual and automated activities. For example, a data scientist can manually tailor, build, train, etc., a ML model via interacting with a system such as the system 1400 while the system 1400 may manage automatic deployment of a ML model of the data scientist. As an example, a framework such as the TIBCO NIMBUS framework can help manage and document various processes. For example, consider an end-to-end view that highlights gaps, redundancies, or inefficiencies, that highlights handoffs between manual and automated activities, etc. Such an approach can include modeling of field sites and field devices at such sites where ML model deployments occur in an organized manner to help assure that processes at the field sites are acceptably run and/or optimized.

As mentioned, a system may manage ML models in a chained approach. For example, consider various ML model implementation decisions at a field site that can cause a chain reaction as to one or more additional ML model implementation decisions.

As an example, a “proof of work” type of approach may be utilized when managing updates to a fleet of field devices at one or more field sites (e.g., to provide a reasonably secure and decentralized consensus for taking subsequent action(s)). Proof of work (PoW) describes a system that demands a not-insignificant but feasible amount of effort in order to deter frivolous or malicious uses of computing power. In a system such as, for example, the system 1400 of FIG. 14, the “work” may be in having a number of instances of a ML model, deployed to field devices, successfully perform one or more tasks in the field. Such an approach can help to determine whether the ML model is performing adequately, which may be determined as to output, ability to handle input, secure operation, etc. Where the PoW is met, a system may then deploy additional instances of the ML model. Such an approach may consider that a number of instances may be performing unacceptably while an additional number of instances are performing acceptably. As an example, a PoW approach may include running instances of ML models in a background while, for example, simultaneously running existing ML model instances in a foreground (e.g., of an old ML model to be replaced). In such an example, if PoW is met, then a trigger may call for switching field devices to bring the background ML models to the foreground (e.g., to replace the existing ML model instances).

As an example, where a PoW metric is trending upwardly with respect to time, such that PoW is expected to be met, a system may consider PoW as having been met in an effort to expedite implementation of ML models in the field. For example, as PoW can depend on available sensor data as to one or more field operations, timing as to PoW can vary from field site to field site, from field device to field device, etc.

As explained, a PoW approach can be utilized due to scale of an ecosystem where, for example, a system aims to manage deployment of ML models in the ecosystem. Where hundreds, thousands, or more field devices are to be managed in the ecosystem, a PoW approach can provide for efficiency, robustness and feedback. Further, the PoW performed at each field device may be meaningful and not considered a “waste”. Where PoW is performed for a particular task or set of tasks, a snapshot of results may be maintained, for example, for comparison to future and/or past results by one or more field devices. Such snapshots (e.g., signatures, etc.) may be analyzed for one or more purposes, optionally, for example, to tailor PoW such that it can be performed reliably in the least amount of time. Where PoW can be performed in a reduced period of time at scale, deployment and implementation of ML models can be expedited.

As an example, a system may deploy ML models to field devices where the ML models include variants. For example, consider variations in one or more parameters of a ML model, which may be relatively small such that chance of success is not impacted. Given such variants, results therefrom may provide insights for a data scientist, particularly as to manners to improve a future generation of an ML model. In such an approach, when implemented at scale, if one or more variants perform unacceptably, they may be updated, for example, with one or more of the variants that demonstrate acceptable performance (e.g., optionally selecting a variant with optimal or the best performance).

As explained, a ML model and metadata approach can reduce transmission demands. In such an example, multiple ML models and/or multiple metadata configurations may be transmitted where such variations can be compared locally in the field to determine which ML model and/or which metadata configuration is to be implemented. Such an approach may operate with minimal downtime in the field and may provide for optimizing field performance and/or reducing demand for one or more updates. For example, a data scientist may transmit top ranked ML models and/or metadata to a device at a remote field site where the device determines which ML model and/or metadata to implement. Such an approach can increase chance of success in a manner that can reduce transmission demands and/or demands on a data scientist. Further, such an approach may be suitable for different fields, different devices, etc. For example, consider two wells with “smart” wellheads where one variation performs better at one well and another variation performs better at the other well. In such an approach, the data scientist does not necessarily have to narrow down choices herself for the two wells; rather, the data scientist can transmit variants where at least one of the variants may be expected to perform adequately when implemented in the field. As explained, a local device can include an assessment component that can provide for comparisons, quality assurance, etc.

As an example, a combination of approaches may be utilized for deployment and implementation at scale. Such a combination can aim to effectively deploy and implement ML models in a manner that reduces time, reduces waste, improves processes, etc. As explained, identical instances may be deployed, variations of instances may be deployed, a field device may run multiple different instances, etc. Such deployments may utilize one or more types of metrics, such as, for example, a PoW metric, a “winner” metric, etc. In such examples, meaningful information can be generated that can provide a data scientist with insights. As an example, a system may provide a data scientist with deployment and implementation at scale options where one or more options may be selected for purposes of gaining insights. In such an example, time saved by the data scientist not having to be concerned with an application container approach may be utilized to determine deployment and implementation strategies at scale where such strategies can provide the data scientist with insights.

As an example, the manager 1440 of the system 1400 of FIG. 14 may provide a data scientist with options as to deployment and implementation at scale such that deployment and/or implementation at scale provide the data scientist with meaningful insights, which can be a basis for ML model improvement. Efficiencies gained from a ML model and/or metadata deployment approach can be utilized for ML model and/or metadata revisions that can result in improved field operations.

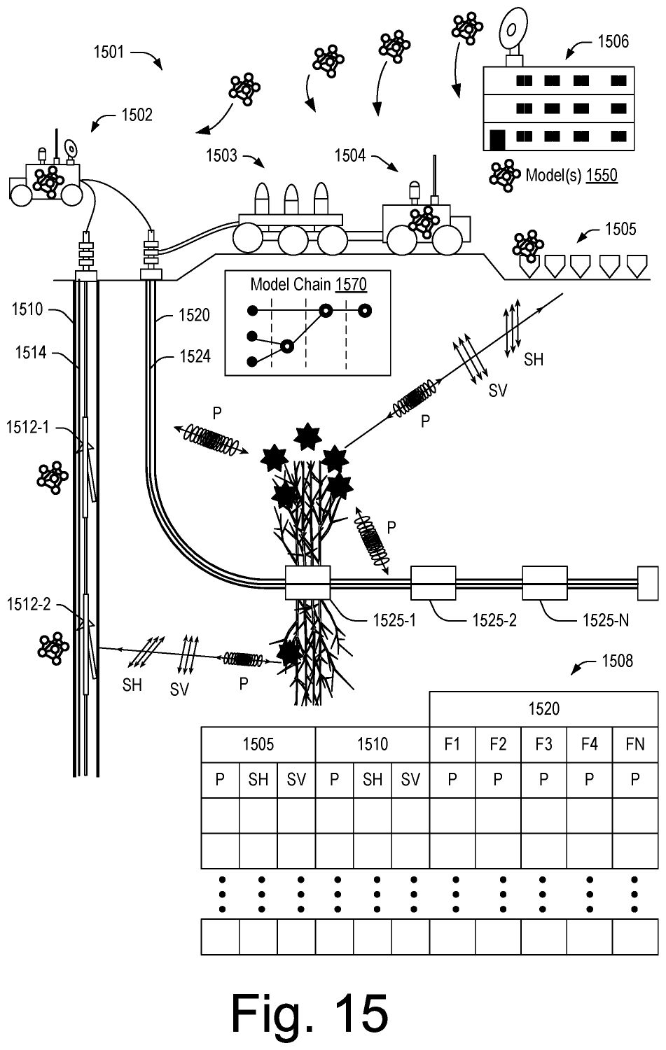

FIG. 15 shows an example of a geologic environment 1501 that includes monitoring equipment 1502, a pump 1503, equipment 1504, a seismic sensor or receiver array 1505 and a remote facility 1506. As shown, various types of communication may be implemented such that one or more pieces of equipment can communicate with one or more other pieces of equipment. As an example, equipment can include geopositioning equipment (e.g., GPS, etc.). As an example, equipment can include one or more satellites and one or more satellite links (e.g., dishes, antennas, etc.).

In the example of FIG. 15, the remote facility 1506 may be a data scientist facility that can deploy models 1550 to the field (see, e.g., model graphic). Such models 1550 can include various types of field models deployable for execution on one or more field devices. As shown in the example of FIG. 15, the models 1550 may be part of a chained approach of deployment and/or implementation, as indicated by a model chain graphic 1570. For example, one or more rules, logic, etc., may be utilized to cause a chained rollout of ML models at a field site. As to rules or logic, consider successful implementation of two ML models for two field devices as being a condition that is to be met before proceeding to implementation of another ML model at another field device, etc.

In the example of FIG. 15, a monitoring well 1510 and a treatment well 1520 are disposed in the geologic environment 1501. The monitoring well 1510 includes a plurality of sensors 1512-1 and 1512-2 and optionally a fiber cable sensor 1514 and the treatment well 1520 optionally includes a fiber cable sensor 1524 and one or more sets of perforations 1525-1, 1525-2, 1525-N (e.g., as generated by perforating equipment, which may utilize force generated via one or more mechanisms).

Equipment in the example of FIG. 15 can be utilized to perform one or more methods. As an example, data associated with hydraulic fracturing events may be acquired via various sensors. As an example, P-wave data (compressional wave data) can be utilized to assess such events (e.g., microseismic events). Such information may allow for adjusting one or more field operations. As an example, data acquired via the fiber cable sensor 1524 can be utilized to generate information germane to a fluid flow-based treatment process (e.g., to determine where fluid pumped into a well may be flowing, etc.).

FIG. 15 shows an example of a table or data structure 1508 with some examples of information that may be acquired via the seismic sensor array 1505 (e.g., P-wave as “P”, SH-wave as “SH”, SV-wave as “SV”), sensors of the monitoring well 810 (e.g., P, SH, SV) and sensors of the treatment well 1520 (e.g., P). In the example of FIG. 15, information may be sensed with respect to position, for example, sensor position, position along a fiber cable sensor, etc. As shown, the fiber cable sensor 1524 may sense information at a variety of positions along the fiber cable sensor 1524 within the treatment well 1520 (see, e.g., F1, F2, F3, F4 to FN).

In the example of FIG. 15, the set of perforations 1525-1 are shown as including associated fractures and microseismic events that generate energy that can be sensed by various sensors in the geologic environment 1501. Arrows indicate a type of wave that may be sensed by an associate sensor. For example, as mentioned with respect to the table or data structure 1508, the seismic sensor array 1505 can sense P, SV and SH waves while the fiber cable sensor 1524 can sense P waves.

As an example, the equipment 1502 can be operatively coupled to various sensors in the monitor well 1510 and the treatment well 1520. As an example, the equipment 1502 may be on-site where wires are coupled from sensors to the equipment 1502, which may be vehicle-based equipment (e.g., a data acquisition and/or control truck, etc.). As an example, the equipment 1504 may control the pump 1503 (e.g., or pumps) that can direct fluid into the treatment well 1520. For example, a line is shown as a conduit that is operatively coupled between the pump 1503 and the treatment well 1520.

As an example, information acquired by the equipment 1502 may be utilized to control one or more treatment processes controlled by the equipment 1504. For example, the equipment 1502 and the equipment 1504 may be in direct and/or indirect communication via one or more communication links (e.g., wire, wireless, local, remote, etc.). In such an example, information acquired during a treatment process can be utilized in real-time (e.g., near real-time) to control the treatment process. For example, the equipment 1502 can acquire data via sensors in the wells 1510 and 1520 and output information to the equipment 1504 for purposes of controlling an on-going treatment process. As an example, such information may be utilized to control and/or to plan a subsequent treatment process, for example, additionally or alternatively to controlling an on-going treatment process.

In the example of FIG. 15, various equipment can include a model or may be operatively coupled to a model framework (e.g., an edge framework, etc.). As shown, the equipment 1502, 1504, 1505, 1512-1, 1512-2, etc., may implement one or more models. In various instances, a model may be suitable for use at multiple wellsites while in other instances a model may be suitable for use at a single wellsite. For example, a downhole signal analysis model may be suitable for use at a single wellsite as particular features may be quite specific to that wellsite. In contrast, a speed control model for controlling speed of deployment of a downhole tool may be applicable at various wellsites. Such differences can be a basis for model and/or metadata updates.

As an example, a treatment process can include hydraulic fracturing. As an example, acquired data can include microseismic event data. As an example, a method can include determining the extent of rock fracturing induced by a treatment process, which may aim to stimulate a reservoir.

A stimulation (or a stimulation treatment) may be performed to restore or enhance the productivity of a well. Types of stimulations can include hydraulic fracturing treatments and matrix treatments. Fracturing treatments can be performed above a fracture pressure of a reservoir formation and aim to create a conductive flow path between the reservoir and a wellbore. Matrix treatments can be performed below a reservoir fracture pressure and may be designed to restore natural permeability of the reservoir (e.g., following damage to the near-wellbore area, etc.). As an example, stimulation in shale gas reservoirs can involve hydraulic fracturing treatments.

As an example, a method can include hydraulic fracture monitoring (HFM). As an example, a method can include monitoring one or more types of reservoir stimulation processes where one or more of such processes may be performed in stages. As an example, a stage may be of a duration of the order of hours or longer (e.g., several days). As an example, a method can include determining the presence, extent, and/or associated volume of induced fractures and fracture networks, which may be utilized for calculating an estimated reservoir stimulation volume (e.g., ESV) that may assist, for example, in economic evaluation of well performance.

As an example, real-time data may be rendered to a display (e.g., as a plot, plots, etc.). As an example, real-time data may be assessed in real-time (e.g., near real-time that includes computation and transmission times) during perforation flow for one or more sets of perforations. In such an example, such assessments may allow a treatment process to be optimized during the treatment process in real-time (e.g., near real-time). Such assessments may be utilized for one or more post treatment analyses, for example, to plan, perform, control, etc. one or more future treatments (e.g., in a same well, a different well, etc.).

As an example, a method can include acquiring data germane to flow in one or more wells and/or via perforations in one or more wells. As an example, a method can include acquiring data germane to locating one or more fractures. As an example, a method can include a real-time portion and a post-process portion.

As an example, a data acquisition technique may be implemented to help understand a formation, a reservoir, a bore, a bore wall, a fracture, fractures, a fracture network, etc. As an example, a hydraulically induced fracture or fractures may be monitored using one or more borehole seismic methods. For example, while a fracture is being created in a treatment well, a multicomponent receiver array in a monitor well may be used to record microseismic activity generated by a fracturing process.

As mentioned, equipment may include fracturing equipment where such equipment may be employed to generate one or more fractures in a geologic environment. As an example, a method to generate fractures can include a delivery block for delivering fluid to a subterranean environment, a monitor block for monitoring fluid pressure and a generation block for generating fractures via fluid pressure. As an example, the generation block may include activating one or more fractures. As an example, the generation block may include generating and activating fractures.

As an example, a method may be referred to as a treatment method or a “treatment”. Such a method may include pumping an engineered fluid (e.g., a treatment fluid) at high pressure and rate into a reservoir via one or more bores, for example, to one or more intervals to be treated, which may cause a fracture or fractures to open (e.g., new, pre-existing, etc.).

As an example, a fracture may be defined as including “wings” that extend outwardly from a bore. Such wings may extend away from a bore in opposing directions, for example, according in part to natural stresses within a formation. As an example, proppant may be mixed with a treatment fluid to keep a fracture (or fractures) open when a treatment is complete. Hydraulic fracturing may create high-conductivity communication with an area of a formation and, for example, may bypass damage that may exist in a near-wellbore area. As an example, stimulation treatment may occur in stages. For example, after completing a first stage, data may be acquired and analyzed for planning and/or performance of a subsequent stage.

Size and orientation of a fracture, and the magnitude of the pressure to create it, may be dictated at least in part by a formation's in situ stress field. As an example, a stress field may be defined by three principal compressive stresses, which are oriented perpendicular to each other. The magnitudes and orientations of these three principal stresses may be determined by the tectonic regime in the region and by depth, pore pressure and rock properties, which determine how stress is transmitted and distributed among formations.

Where fluid pressure is monitored, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

As an example, a method may include seismic monitoring during a treatment operation (e.g., to monitor fracture initiation, growth, etc.). For example, as fracturing fluid forces rock to crack and fractures to grow, small fragments of rock break, causing tiny seismic emissions, called microseisms. Equipment may be positioned in a field, in a bore, etc. to sense such emissions and to process acquired data, for example, to locate microseisms in the subsurface (e.g., to locate hypocenters). Information as to direction of fracture growth may allow for actions that can “steer” a fracture into a desired zone(s) or, for example, to halt a treatment before a fracture grows out of an intended zone. Seismic information (e.g., information associated with microseisms) may be used to plan one or more stages of fracturing operations (e.g., location, pressure, etc.).

Various processes in the example of FIG. 15 can utilize one or more ML models (e.g., with or without metadata). For example, consider one or more ML models utilized to locally analyze microseismic data to provide output indicating extent of one or more fractures performed by hydraulic fracturing equipment. As an example, where fracturing occurs stage-by-stage over time, re-training of a ML model may occur after a stage such that an improved ML model may be deployed for a next stage. As explained, a system that can deploy ML models in a lightweight manner may be able to handle frequent downloads and may be able to help focus a data scientist on a model and/or metadata rather than on application deployment.

As explained, a system can provide for streamlining the process of deploying machine learning and AI models to field sites. Such a system can reduce demands on data scientists to write code and can help shift their focus to model optimization. Such a system can enable data scientists to iterate faster and continuously improve their models deployed for field use (see, e.g., stage-by-stage fracturing, etc.). A system may utilize a deployable unit that includes a model and its metadata; rather than an application and model container. As explained, various techniques may be employed to provide for robust model adoption at a field device. For example, multiple variants may be deployed (e.g., optionally in a phased manner) where a “winner” may be determined locally, which may inform further deployment, development, etc. Such an approach may help to reduce frequency of deployments, where desired.

As explained, a system may provide for lifecycle management of machine learning models. As explained, an inference engine and supporting code can be included in a reconfigurable module that is part of a framework that is suitable for use as an edge framework (EF). As an example, a system can provide for predefining workflows for taking ML models from development to production and for workflows for deploying models to an existing container in the edge via a file download workflow.

As explained, a system can provide a no code approach for data scientists, a faster development cycle, smaller deployable units suitable for low bandwidth communication channels such as satellite, and an optimized edge ML runtime environment.

As an example, a system can provide for faster time to market, lesser cost of deployment, more efficient use of edge resources and better overall performance. As explained, a ML model may perform one or more tasks in the field. For example, consider generating output for another field device, tagging data, assessing data quality, etc.

As an example, a system can provide a vault of ML models that may be searchable. For example, consider a data scientist being tasked with deployment of a ML model to 100 wells in a particular field where the vault includes ML models for an analogue field. In such an example, the data scientist may access the vault and identify an appropriate analogue ML model. In such an example, the data scientist may identify appropriate training data for the field of interest, which may be analogue field data (e.g., where data for the field of interest is not existing to a quantity sufficient for training, etc.).

As explained, a field device may receive input from one or more sources. As an example, metadata associated with a ML model may provide for input binding and/or output binding such that configuration of an edge inference is appropriately performed to bind to edge input and/or output data.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange to various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

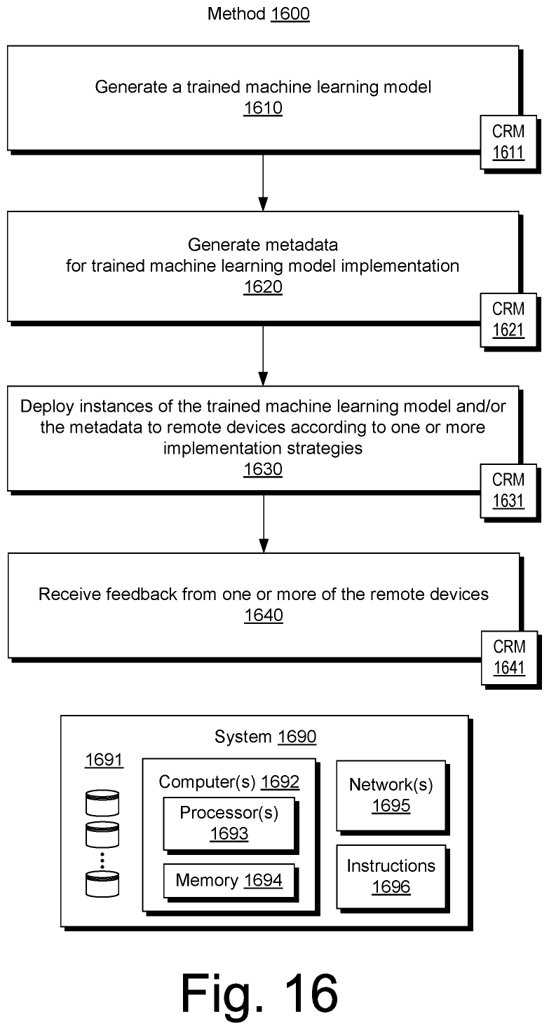

FIG. 16 shows an example of a method 1600 that includes a generation block 1610 for generating a trained machine learning model; a generation block 1620 for generating metadata for trained machine learning model implementation; and a deployment block 1630 for deploying instances of the trained machine learning model, the metadata or the trained machine learning model and the metadata to remote devices according to one or more implementation strategies. As shown, the method 1600 can include a reception block 1640 for receiving feedback from one or more of the remote devices, which, for example, may provide guidance for one or more of the generation blocks 1610 and 1620.

In the example of FIG. 16, a system 1690 includes one or more information storage devices 1691, one or more computers 1692, one or more networks 1695 and instructions 1696. As to the one or more computers 1692, each computer may include one or more processors (e.g., or processing cores) 1693 and memory 1694 for storing the instructions 1696, for example, executable by at least one of the one or more processors. As an example, a computer may include one or more network interfaces (e.g., wired or wireless), one or more graphics cards, a display interface (e.g., wired or wireless), etc.

The method 1600 is shown along with various computer-readable media blocks 1611, 1621, 1631 and 1641 (e.g., CRM blocks). Such blocks may be utilized to perform one or more actions of the method 1600. For example, consider the system 1690 of FIG. 16 and the instructions 1696, which may include instructions of one or more of the CRM blocks 1611, 1621, 1631 and 1641.

As an example, a system can include a machine learning model training framework that generates trained machine learning models; a metadata configurer that generates metadata for trained machine learning model implementation; and a deployment manager that deploys trained machine learning models, metadata or trained machine learning models and metadata to remote devices according to one or more implementation strategies. In such an example, the remote devices can be or include field devices. As an example, a field device can be a wellsite field device. For example, consider field devices as including one or more of a wellhead field device, a surface network field device, a hydraulic fracturing field device, a seismic sensing field device, a flare monitoring field device, a drilling fluid field device, a drilling rig field device, a downhole field device, and a drone field device. As an example, field devices can include one or more gateway field device where, for example, the gateway field device is operatively coupled to at least one other field device and/or the gateway field device controls implementation of one or more deployed trained machine learning models.

As an example, a deployment manager can deploy implementation instructions to at least one of a plurality of remote devices. For example, consider implementation instructions that are executable by a gateway field device and/or implementation instructions that include implementation rules and/or logic.

As an example, one or more implementation strategies can include a variant strategy that deploys variants of a trained machine learning model. In such an example, variants may be generated using one or more techniques. For example, consider an approach that varies one or more parameters, which may be selected randomly or otherwise from a range, a distribution, etc. As an example, variants may include prior models and/or present models. As an example, variants may aim to provide feedback as to a particular parameter or set of parameters of a model. For example, consider use of variants as part of an optimization strategy, which may aim to optimize models for a site, for a plurality of sites, for particular sites, etc.

As an example, one or more implementation strategies can include a multiple model contest strategy that deploys a trained machine learning model as an entry to a multiple model contest. In such an example, a local device or local devices may run multiple models where output of such models may be or may not be utilized for control, etc. For example, consider running a first model for control while running a second model in the background and then running the second model for control and running the first model in the background. In such an example, results from running both models (e.g., for control and/or in the background) can be assessed to determine which model performs better and/or to determine under what circumstances each of the models performs better. As an example, a hybrid model may be generated based on such results and/or one or more rules may be utilized to run one of the models responsive to certain circumstances and run another one of the models responsive to different circumstances. For example, consider pressure, temperature, flow rates, etc., ranges where one may perform better than another. As to flow, consider laminar versus turbulent flow as may be determined by the Reynolds number; noting various other dimensionless numbers or other approaches may be utilized in a rule-based or hybrid-based approach.

As an example, one or more implementation strategies can include a proof of work strategy. For example, consider a proof of work strategy that calls for running trained machine learning models in a background mode until a consensus proof of work metric is met. As an example, a proof of work metric may be determined, selected, etc., based on experience, level of robustness, rate toward consensus, etc.

As an example, metadata can include input binding metadata and/or preprocessing metadata.

As an example, remote devices can include remote devices with runtime engines configurable to run deployed trained machine learning models. In such an example, metadata may be utilized to configure one or more of the runtime engines.

As an example, a deployment manager can include a graphical user interface for selection of one or more implementation strategies. As explained, an implementation strategy may provide feedback that can be utilized for one or more purposes.

As an example, a method can include generating a trained machine learning model; generating metadata for trained machine learning model implementation; and deploying instances of the trained machine learning model, the metadata or the trained machine learning model and the metadata to remote devices according to one or more implementation strategies.

As an example, one or more computer-readable media can include computer-executable instructions executable by a system to instruct the system to: generate a trained machine learning model; generate metadata for trained machine learning model implementation; and deploy instances of the trained machine learning model, the metadata or the trained machine learning model and the metadata to remote devices according to one or more implementation strategies.

As an example, a computer program product can include one or more computer-readable storage media that can include processor-executable instructions to instruct a computing system to perform one or more methods and/or one or more portions of a method.

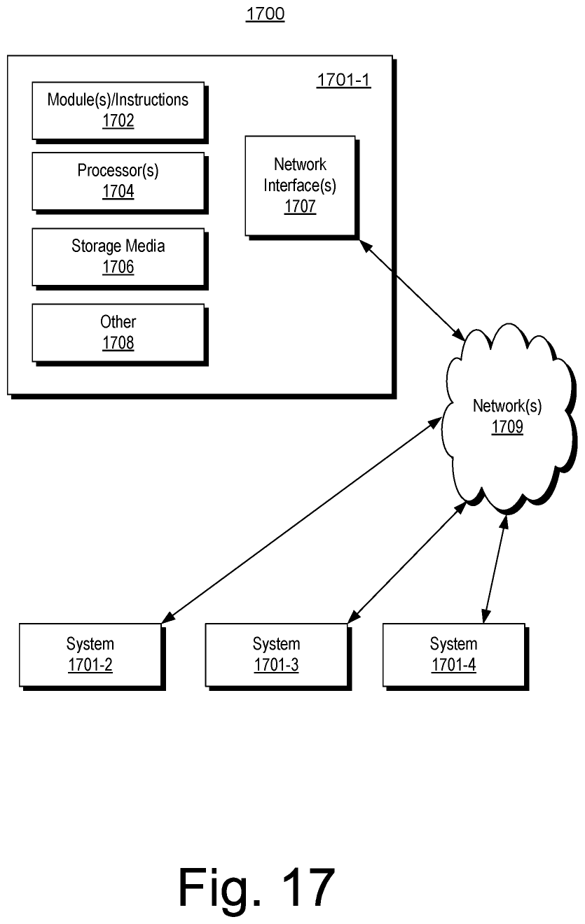

In some embodiments, a method or methods may be executed by a computing system. FIG. 17 shows an example of a system 1700 that can include one or more computing systems 1701-1, 1701-2, 1701-3 and 1701-4, which may be operatively coupled via one or more networks 1709, which may include wired and/or wireless networks.

As an example, a system can include an individual computer system or an arrangement of distributed computer systems. In the example of FIG. 17, the computer system 1701-1 can include one or more modules 1702, which may be or include processor-executable instructions, for example, executable to perform various tasks (e.g., receiving information, requesting information, processing information, simulation, outputting information, etc.).

As an example, a module may be executed independently, or in coordination with, one or more processors 1704, which is (or are) operatively coupled to one or more storage media 1706 (e.g., via wire, wirelessly, etc.). As an example, one or more of the one or more processors 1704 can be operatively coupled to at least one of one or more network interface 1707. In such an example, the computer system 1701-1 can transmit and/or receive information, for example, via the one or more networks 1709 (e.g., consider one or more of the Internet, a private network, a cellular network, a satellite network, etc.).

As an example, the computer system 1701-1 may receive from and/or transmit information to one or more other devices, which may be or include, for example, one or more of the computer systems 1701-2, etc. A device may be located in a physical location that differs from that of the computer system 1701-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1706 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

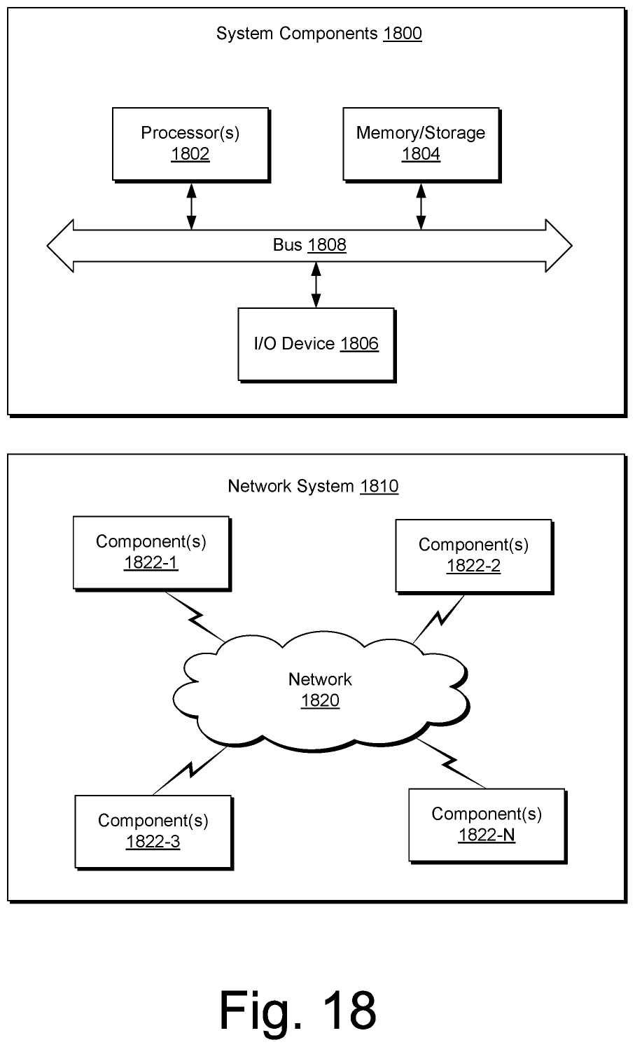

FIG. 18 shows components of an example of a computing system 1800 and an example of a networked system 1810 with a network 1820. The system 1800 includes one or more processors 1802, memory and/or storage components 1804, one or more input and/or output devices 1806 and a bus 1808. In an example embodiment, instructions may be stored in one or more computer-readable media (e.g., memory/storage components 1804). Such instructions may be read by one or more processors (e.g., the processor(s) 1802) via a communication bus (e.g., the bus 1808), which may be wired or wireless. The one or more processors may execute such instructions to implement (wholly or in part) one or more attributes (e.g., as part of a method). A user may view output from and interact with a process via an I/O device (e.g., the device 1806). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1810. The network system 1810 includes components 1822-1, 1822-2, 1822-3, . . . 1822-N. For example, the components 1822-1 may include the processor(s) 1802 while the component(s) 1822-3 may include memory accessible by the processor(s) 1802. Further, the component(s) 1822-2 may include an I/O device for display and optionally interaction with a method. A network 1820 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A system comprising:
a machine learning model training framework that generates trained machine learning models;
a metadata configurer that generates metadata for trained machine learning model implementation; and
a deployment manager that deploys trained machine learning models, metadata or trained machine learning models and metadata to remote devices according to one or more implementation strategies.

2. The system of claim 1, wherein the remote devices comprise field devices.

3. The system of claim 2, wherein the field devices comprise one or more of a wellhead field device, a surface network field device, a hydraulic fracturing field device, a seismic sensing field device, a flare monitoring field device, a drilling fluid field device, a drilling rig field device, a downhole field device, and a drone field device.

4. The system of claim 2, wherein the field devices comprise a gateway field device.

5. The system of claim 4, wherein the gateway field device is operatively coupled to at least one other field device.

6. The system of claim 4, wherein the gateway field device controls implementation of one or more deployed trained machine learning models.

7. The system of claim 1, wherein the deployment manager deploys implementation instructions to at least one of the remote devices.

8. The system of claim 7, wherein the implementation instructions are executable by a gateway field device.

9. The system of claim 7, wherein the implementation instructions comprise implementation rules and/or logic.

10. The system of claim 1, wherein the one or more implementation strategies comprise a variant strategy that deploys variants of a trained machine learning model.

11. The system of claim 1, wherein the one or more implementation strategies comprise a multiple model contest strategy that deploys a trained machine learning model as an entry to a multiple model contest.

12. The system of claim 1, wherein the one or more implementation strategies comprise a proof of work strategy.

13. The system of claim 12, wherein the proof of work strategy calls for running trained machine learning models in a background mode until a consensus proof of work metric is met.

14. The system of claim 1, wherein the metadata comprise input binding metadata.

15. The system of claim 1, wherein the metadata comprise preprocessing metadata.

16. The system of claim 1, wherein the remote devices comprise remote devices with runtime engines configurable to run the deployed trained machine learning models.

17. The system of claim 16, wherein the metadata configure the runtime engines.

18. The system of claim 1, wherein the deployment manager comprises a graphical user interface for selection of one or more of the one or more implementation strategies.

19. A method comprising:
generating a trained machine learning model;
generating metadata for trained machine learning model implementation; and
deploying instances of the trained machine learning model, the metadata or the trained machine learning model and the metadata to remote devices according to one or more implementation strategies.

20. One or more computer-readable media comprising computer-executable instructions executable by a system to instruct the system to:
generate a trained machine learning model;
generate metadata for trained machine learning model implementation; and
deploy instances of the trained machine learning model, the metadata or the trained machine learning model and the metadata to remote devices according to one or more implementation strategies.
